(19) United States
(12) Patent Application Publication
(10) Pub. No.: US 2018/0353869 A1
(43) Pub. Date: Dec. 13, 2018

(54) APPARATUS AND METHOD FOR AN INTERACTIVE ENTERTAINMENT MEDIA DEVICE

(71) Applicant: Lyrebird Interactive Holdings Pty Ltd, Panania (AU)

(72) Inventor: Daniel Robert CORKIN, Panamia (AU)

(73) Assignee: Lyrebird Interactive Holdings Pty Ltd, Panania (AU)

(21) Appl. No.: 16/062,886

(22) PCT Filed: Dec. 16, 2016
(86) PCT No.: PCT/AU2016/000399

§ 371 Date: Jun. 15, 2018

(30) Foreign Application Priority Data
Dec. 17, 2015 (AU) 2015905244

(51) Int. Cl. A63H 5/00; A63F 13/00; G06F 17/30

(52) U.S. Cl. CPC A63H 5/00; A63H 2200/00; G06F 17/30017; A63F 13/00

(57) ABSTRACT

The present invention relates to a system comprising an entertainment media device, a control object comprising an identifier detectable by the entertainment media device; and a storage device comprising a database storing associations between one or more identifiers with control information, the control information being control functions operable by a processor of the entertainment media device. When the control object is placed near a detection area of the entertainment media device, the device determines the identifier of the detected control object; retrieves, from the database, control information of the entertainment media device associated with the determined identifier; and executes the control information.

### CROSS-REFERENCE TO RELATED APPLICATIONS

This application is a National Stage of International Application No. PCT/AU2016/000399, filed Dec. 16, 2016, which claims priority to Australian Patent Application No. 2015905244, filed on Dec. 17, 2015, both of which are hereby incorporated by reference in their entireties.

### TECHNICAL FIELD

The present invention relates generally to control of devices and, in particular, to control of entertainment media devices that are used by children.

### BACKGROUND

Multimedia content, such as images, audio and video, has become ubiquitous in a child's playtime. There are many existing arrangements that enable distribution and viewing of such media content, but these arrangements do not cater for a child's limited capabilities or enable the parent to monitor and control the child's access to said content. Multimedia content is typically distributed using a physical medium (e.g. DVD) or an online service (e.g., downloaded or streamed). Accessing and viewing of multimedia content using existing arrangements may be a difficult experience for a child and generally not intended to be used as, or associated with, a children's device (e.g., a toy).

Children may have access to many physical toys and real world tangible objects. However, children are generally unable to understand that existing physical media is not a play item and that the physical media needs to be properly handled, stored and maintained to reduce the risk of damage to the media itself or the media player.

There may also be some hesitation for parents in allowing children to use current devices such as computers, tablets or phones as a play device. Catering for children and controlling how a child interacts with a device is an important aspect that is not available with existing arrangements.

There exists various wireless Standards for communication between two or more devices. Active wireless devices using these Standards (e.g., Wi-Fi, Bluetooth, and the like) typically require an in-built power source in the device to communicate. On the other hand, passive wireless communication devices using these Standards (e.g., Radio Frequency Identification, Near Field Communication, and the like) obtain power via the received signal. However, configuring these systems and devices to operate properly or to work alongside another product can be difficult and daunting for adults, let alone children.

### SUMMARY

It is an object of the present invention to substantially overcome, or at least ameliorate, one or more disadvantages of existing arrangements.

An aspect of the present disclosure provides a system comprising: an entertainment media device comprising: a first processor; a first computer readable medium in communication with the first processor, the first computer readable medium comprising first computer program codes that are executable by the first processor to operate the entertainment media device; and a first control interface module in communication with the first processor, the first control interface module being configured for detecting the presence of a control object within a detection area of the first control interface module; a control object comprising an identifier detectable by the first control interface module of the entertainment media device; a storage device comprising a database storing associations between one or more identifiers with control information, the control information being control functions operable by the processor of the entertainment media device; wherein the first processor carries out the steps of: determining, by the first control interface module, the identifier of the detected control object; retrieving, from the database, control information of the entertainment media device associated with the determined identifier; and executing the control information on the entertainment media device.

An aspect of the present disclosure provides a method of operating a system comprising: an entertainment media device comprising a first processor; a first computer readable medium in communication with the first processor, the first computer readable medium comprising first computer program codes that are executable by the first processor to operate the entertainment media device; and a first control interface module in communication with the first processor, the first control interface module being configured for detecting the presence of a control object within a detection area of the first control interface module; a storage device comprising a database storing associations between one or more identifiers with control information, the control information being control functions operable by the processor of the entertainment media device; a control object comprising an identifier detectable by the first control interface module of the entertainment media device; the method comprising:

determining, by the first control interface module, the identifier of the detected control object;
retrieving, from the database, control information of the entertainment media device associated with the determined identifier; and
executing the control information on the entertainment media device.

Another aspect of the present disclosure provides a computer program product comprising software instructions, the software instructions executable by a system to cause the system to perform the method described above.

Aspects of the present disclosure provide removal of complex operations and restrictions of existing arrangements to simplify interactions with media devices and enable ease of operation of such media devices. Such a removal of complex operations empowers a child to select and interact with media content, thereby enabling a new method of media distribution.

According to an aspect of the present disclosure, there is provided a system for operating an entertainment media device using control objects, wherein, when the entertainment media device detects the control objects within a detection area, the operation of the entertainment media device is altered.

Preferably, the entertainment media device is configured to detect a control object which is associated with media content and respond accordingly by playing back media content.

Preferably, the detection area is configured to include a path through or along which a control object may pass, such that placement or positioning of a control object along or on the path enables the entertainment media device to detect the control object and perform the related control functions, and allow the control object to be removed from the detection area after the control object has been detected by the entertainment media device. Preferably, the interaction between the control object and the path prevents the same control object from being detected multiple times by the entertainment media device.

Preferably, a second control object may interact with a first control object within the path to ensure there that only a single object may interact with the scan area. Thus, a child may be encouraged to use only a single control object at a given time.

Preferably, the path includes an inclined surface to enable the control objects to move along the inclined surface.

Preferably, the detection area has distinct locations, wherein each distinct location enables the same control object to instruct the entertainment media device to perform different operations.

Preferably, the entertainment media device does not respond to repeated placements of a control object on the detection area while playback of media content related to the same control object is in progress.

Preferably, the same control object is enabled to cause the entertainment media device to perform different operations depending on the operational state of the entertainment media device.

Preferably, the entertainment media device is remotely controlled by a controller device to perform different operations or to alter the state of the entertainment media device.

Preferably, a controller device can control the entertainment media device to cause the entertainment media device to pair with and operate a peripheral device. Preferably, a controller device can directly or indirectly alter the media or instructions associated with a control object. Preferably, the controller device may indirectly alter the media or instructions through the entertainment media device or through a server.

Preferably, the entertainment media device is able to playback media content associated with a control object on another peripheral device (e.g., a TV via, for example, a TV dongle).

Preferably, the entertainment media device is able to retrieve and/or play media content stored external to entertainment media device when a control object is within range of the detection area.

Preferably, the entertainment media device is configured to play a portion of media content upon detecting a control object.

Preferably, the media content or a portion of the media content is playable on a peripheral device paired with the entertainment media device.

Preferably, a control object is associated with a media content and this media content is represented on a display of the control object.

Preferably, a control object includes a display that represents media content. Preferably, the display is dynamically updatable. Preferably, the dynamic update of the display is performed when the control object is within the detection area of the entertainment media device. Preferably, the dynamic display is updateable by the controller device.

Preferably, the entertainment media device is used as a remote messaging system, such that messages are exchanged between the entertainment media device and a peripheral device.

Preferably, the media content associated with an identifier of a control object is changed when the control object is within a detection area of an entertainment media device.

Preferably, a peripheral device is configured to pair with the entertainment media device and provide information related to a control object. Other aspects of the present disclosure are also disclosed.

Preferably, a control object may be characterised by its identifiable features to determine a set of control information

Preferably, a control object may be characterised by its identifiable features against a stored templates to infer the control information that best suits the characterised features.

### BRIEF DESCRIPTION OF THE DRAWINGS

At least one embodiment of the present invention will now be described with reference to the drawings, in which:

FIG. 1 shows an entertainment media system;

FIGS. 2A and 2B collectively form a schematic block diagram representation of the entertainment media device of the entertainment media system shown in FIG. 1;

FIGS. 3A and 3B show an example structure of a control object of the entertainment media system of FIG. 1;

FIG. 4 shows an example of a peripheral device of the entertainment media system of FIG. 1;

FIG. 5 is a flow diagram of a method of controlling the entertainment media device by the control object;

FIGS. 6A to 61 and 7 display example structures of the entertainment media device shown in FIGS. 2A and 2B; and

FIGS. 8A and 8B, 9 to 12, 13A, 13B, 14A, 14B, 15, 16A, 16B, and 17A to 17C show examples of applications of the entertainment media system.

### DETAILED SYSTEM DESCRIPTION

Where reference is made in any one or more of the accompanying drawings to steps and/or features, which have the same reference numerals, those steps and/or features have for the purposes of this description the same function(s) or operation(s), unless the contrary intention appears.

### Overview

Disclosed is an arrangement of an entertainment media device that is controllable via control objects. In use, the entertainment media device detects the presence of one of the control objects and, in response to detecting the presence of the control object, the entertainment media device determines an identifier (e.g., an electronic identifier, shape, colour, and the like) of the detected control object and retrieves, via a control information association, control information associated with the identifier. The entertainment media device then performs an action based on the retrieved control information.

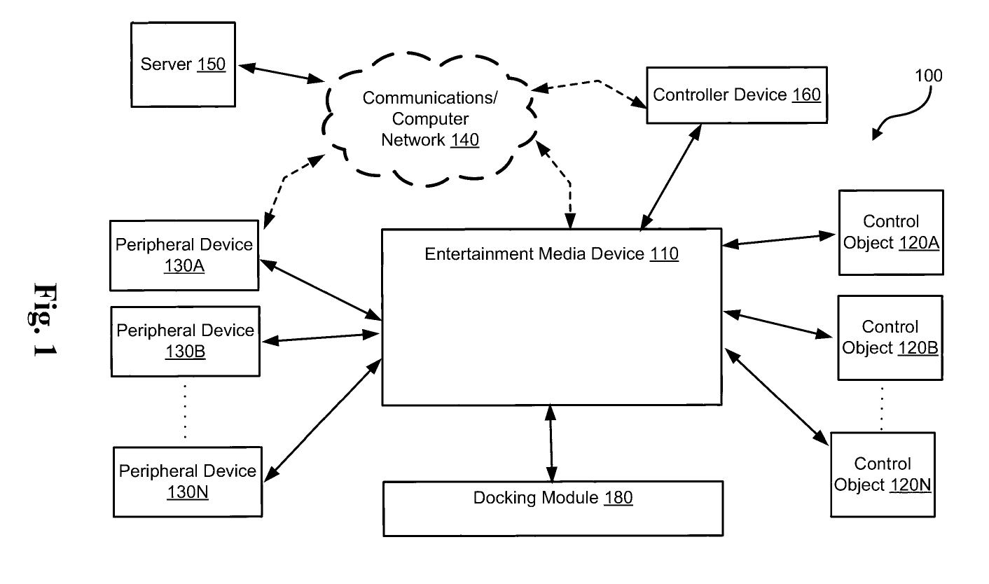

FIG. 1 shows an entertainment media system 100 comprising an entertainment media device 110, control objects 120A, 120B, . . . , 120N, peripheral devices 130A, 130B, . . . , 130N, a controller device 160, a communications/computer network 140, a server 150, and a docking module 180.

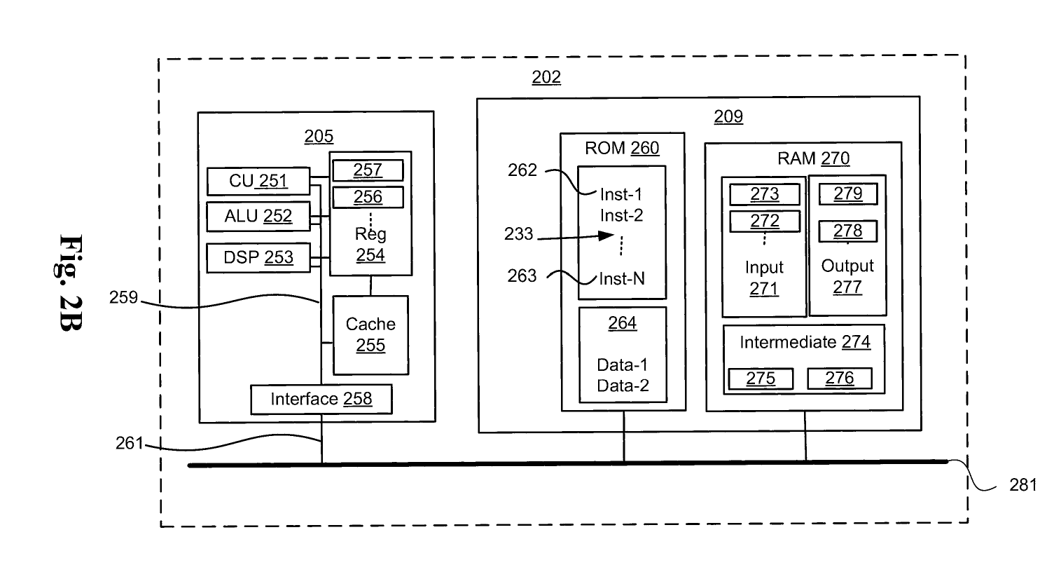

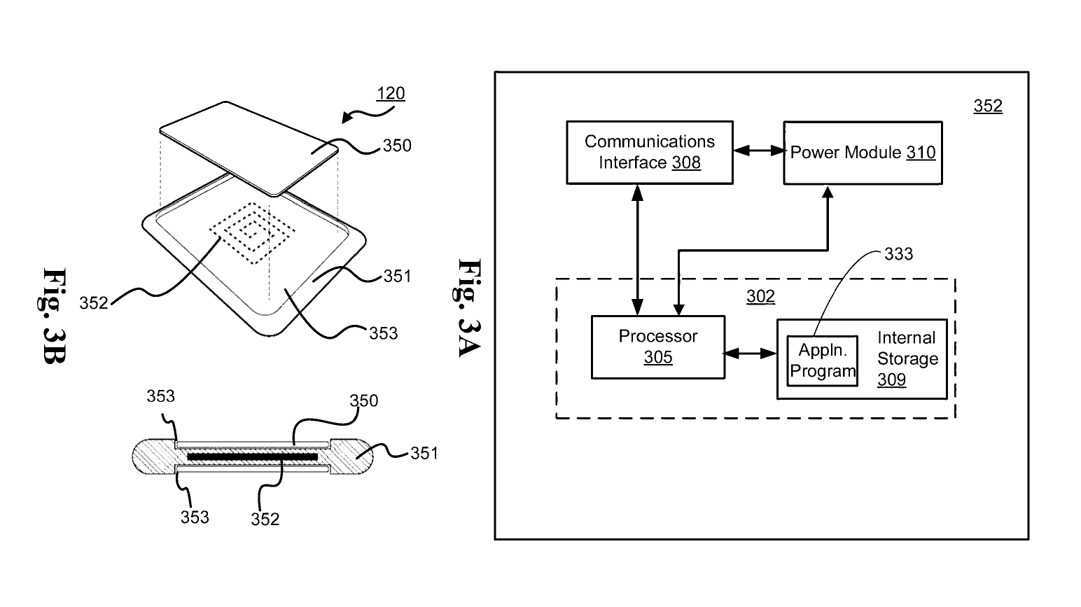

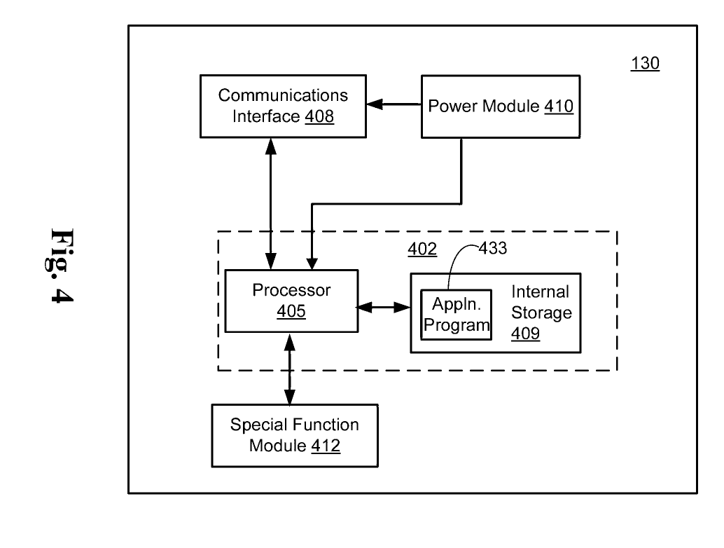

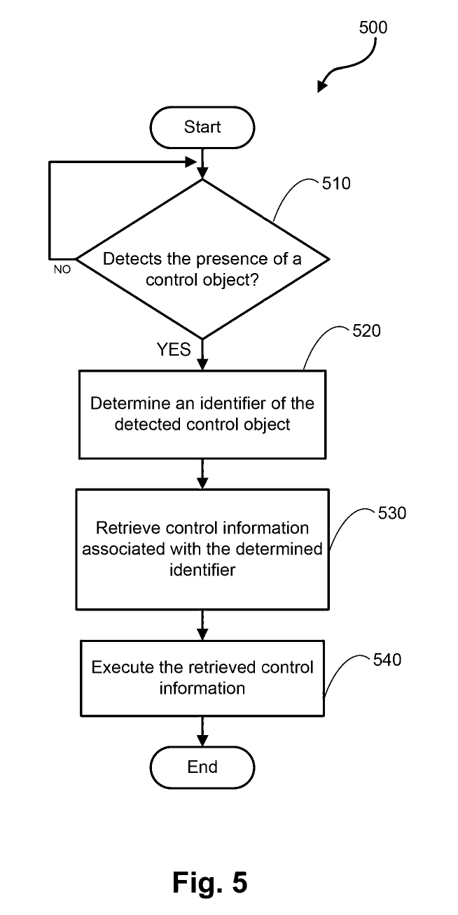

The entertainment media device 110 is a media player that is capable of playing media content (e.g., video content, audio content, and the like). The device 110 may be in the form of a toy that is also capable of, for example, moving parts of the toy, flashing lights, outputting sound and the like. The entertainment media system 100 generally will be described in the present disclosure in relation to a toy operable by children. However, a person skilled in the art would appreciate that the application of the entertainment media system 100 is not limited to toys only. The device 110 will be described in detail in relation to FIGS. 2A, 2B and 5.

The control objects 120A, 120B, . . . , 120N are objects having identifiers (e.g., shape, colour, electronic or printed identifiers, or the like) that are associated with control information (e.g., play media content, pause playing of media content, increase or decrease volume, change mode of operation, etc.) of the device 110. When the control objects 120A, 120B, . . . , 120N are located in a detection area of the device 110, the device 110 performs tasks associated with the control information associated with the identifiers of the control objects 120A, 120B, . . . , 120N. Hereinafter, the control objects 120A, 120B, . . . , 120N will be generally referred to as the control objects 120 (as shown in FIG. 2A) and each of the control objects 120 will be referred to as the control object 120.

The response to a control object 120 in a scan area 224 may differ depending on the operational state of the device 110 under control of the processor 205. For example, if the device 110 is playing audio content initiated by a control object 120A, then the device 110 may ignore the same scan object 120A while this audio content is playing.

The control objects 120 may also have identifiers that are associated with control information relating to the operation of the control objects 120, the peripheral device 130, the controller device 160, and the server 150. For example, when the control objects 120 are placed in the detection area of the device 110, the control information may be for the device 110 to change the operational state of a peripheral device 130.

The peripheral devices 130 are devices that can be connected to the device 110 to put information into and/or get information (e.g., audio/video media content, control signals, sensor data, etc.) out of the device 110. Hereinafter, the peripheral devices 130A, 130B, . . . , 130N will be generally referred to as the peripheral devices 130 (as shown in FIG. 2A) and each of the peripheral devices 130 will be referred to as the peripheral device 130.

The controller device 160 is a device that can be connected to the device 110 to communicate with the device 110 to remotely control and/or configure the device 110. Examples of the controller device 160 are tablet devices, smartphones, laptops, desktop computers, remote control units and the like. In particular, the controller device 160 is used to remotely control the functionality of the device 110, such as configuring the responses of a control object, commencing playback of media content on the device 110, changing the mode of operation of the device 110, communicating with the device 110 and the like.

The device 110 is also capable of communicating with the server 150 via the communications/computer network 140. Although the network 140 is depicted in FIG. 1 to be one cloud, the network 140 may comprise combinations of two or more communications networks, such as mobile communications networks, local area networks, wide-area networks, and the like. The server 150 may operate as a “cloud infrastructure” to manage the functionality of the device 110, the controller device 160 and/or the peripheral device 130.

The server 150 may include an arrangement of various physical hardware and/or software components. Hardware components, for example, include computing resources, networking elements, physical storage resources (e.g., solid state, magnetic disks), switches, and the like. Software components of the cloud infrastructure may include databases, cloud management, security, encryption/decryption, user profile management, operating systems, file systems, Application Programming Interfaces (API's) and the like.

Hardware and/or software of the server 150 may be further configured to provide, for example, firewalls, network address translators, load balancers, digital rights management (DRM), virtual private network (VPN) gateways, Dynamic Host Configuration Protocol (DHCP) routers, digital asset management (DAM), and the like.

Furthermore, the cloud infrastructure may be a combination of one or more cloud infrastructures and/or virtualization servers along with other specialized components to provide network virtualizations, storage virtualizations, managing the rights and licensing of content, and the like, or to interface with a 3^{rd} party cloud infrastructure or digital-rights lockers and configured to provide a network service to end users of the system 100.

One example function of the server 150 is to store the database that relates control information of the device 110 with the identifiers of the control objects 120.

The device 110 also has a docking module 180, on which the device 110 can be docked. Example functionality of the docking module 180 includes charging the power storage device in the device 110, acting as a bridge between a peripheral device 130 and the device 110, and the like. In one arrangement, the device 110 may be a toy with a battery that is chargeable when the device 110 is docked on the docking module 180. However, in some arrangements, the docking module 180 may be integrated within, i.e. built into, the device 110.

In another arrangement, the device 110 may also communicate with another device 110 of another system to enable collaborative functionality. For example, in the case where the device 110 is a toy, the device 110 can interact with another device 110 to enable advanced gameplay for a child, where, for example, the control object 120 acts as a gameplay item that is capable of altering the response and operational state of each of the devices 110.

### Entertainment Media Device 110

As described hereinbefore, the entertainment media device 110 is a media player that is capable of playing media content (e.g., video content, audio content, and the like). The device 110 may be in the form of a toy that is also capable of, for example, moving parts of the toy, flashing lights and the like.

FIGS. 2A and 2B collectively form a schematic block diagram of the entertainment media device 110. In the example arrangement shown in FIGS. 2A and 2B, the processing resources of the entertainment media device 110 are limited. However, the entertainment media device 110 may be implemented on higher-level devices such as desktop computers, server computers, and other such devices with significantly larger processing resources.

As seen in FIG. 2A, the entertainment media device 110 comprises an embedded controller 202. In the present example, the controller 202 has a processing unit (or processor) 205 which is bi-directionally coupled to an internal storage module 209. The storage module 209 may be formed from non-volatile semiconductor read only memory (ROM) 260 and semiconductor random access memory (RAM) 270, as seen in FIG. 2B. The RAM 270 may be volatile, non-volatile or a combination of volatile and non-volatile memory.

The entertainment media device 110 may also include a display controller 207, which is connected to a video display 214, such as a liquid crystal display (LCD) panel, LED matrix display or the like. The display controller 207 is configured for displaying graphical images on the video display 214 in accordance with instructions received from the embedded controller 202, to which the display controller 207 is connected.

The entertainment media device 110 includes an audio interface 211, which is connected to a speaker 215 or a microphone 216. The audio interface 211 is configured for outputting sound on the speaker 215 in accordance with instructions received from the embedded controller 202. The audio interface 211 is also configured for receiving signals from a microphone 216 for processing by the embedded controller 212.

The entertainment media device 110 also includes user interface 212 to enable the device 110 to receive commands from a user. The user interface 212 may be implemented using keypads or a touchscreen in-built into the device 110.

The entertainment media device 110 also includes input/output interfaces 213 configured for coupling the device 110 with the peripheral devices 130 and/or the controller device 160 via a connection 222. The connection 222 may be wired or wireless. Examples of wired connections are the Universal Serial Bus (USB) connectors, IEEE 1394 connectors, and the like. Examples of wireless connections are Bluetooth™, Infrared Data Association (IrDa), Near Field Communication (NFC) and the like. The connections between the peripheral devices 130 and the input/output interfaces 213 are dependent on the technology used by the peripheral devices 130. Similarly, the connections between the controller device 160 and the input/output interfaces 213 are dependent on the technology used by the controller device 160.

As seen in FIG. 2A, the entertainment media device 110 also comprises a portable memory interface 206, which is coupled to the processor 205 via a connection 219. The portable memory interface 206 allows a complementary portable memory device 225 to be coupled to the entertainment media device 110 to act as a source or destination of data or to supplement the internal storage module 209. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The entertainment media device 110 also has a communications interface 208 to permit coupling of the device 110 to a computer or communications network 140 via a connection 221. The connection 221 may be wired or wireless. For example, the connection 221 may be radio frequency or optical. An example of a wired connection includes Ethernet. Further, an example of wireless connection includes Bluetooth™, Wi-Fi (including protocols based on the standards of the IEEE 802.11 family), IrDa and the like. The server 150 is coupled to the computer/communications network 140 to permit communications between the device 110 with the server 150.

In one arrangement, the peripheral devices 130 may also be configured for coupling to the computer/communications network 140 to permit communications between the peripheral devices 130 and the device 110. In another arrangement, the controller device 160 may also be configured for coupling to the computer/communications network 140 to permit communications between the controller device 160 and the device 110.

The entertainment media device 110 also comprises a control interface module 210 to enable the device 110 to detect and communicate with the control objects 120 via connection 223. The connection 223 includes contact or non-contact interactions. Examples of non-contact interaction are NFC, RFID, IrDa, optical-based recognition system (such as barcodes or Quick Response codes), 2D/3D object recognition system, RGB/IR identification system, electronic beacons, and the like. Examples of contact interaction include direct or indirect measurement of the properties (such as electrical resistance, component size/shape, reflective colour, and the like) of the control object 120.

The connection 223 also has a detection area 224 on which the control interface module 210 is able to detect the presence of the control objects 120 and determine the identifiers of the control objects 120. In arrangements where the control object 120 is powered, the control object 120 has an in-built processor and memory. Typically, a powered control object 120 uses either active or passive wireless communication methods, such as NFC, RFID, IrDa and the like. In such arrangements, the control interface module 210 transmits a control signal to the control object 120 requesting an identifier of the control object 120 and/or information stored in memory 409. In response to the requesting control signal, the control object 120 transmits the identifier of the control object 120 or the stored information to the processor 205 via the control interface module 210. The control interface module 210 is also configured to communicate with (i.e., read from or write to) the control objects 120.

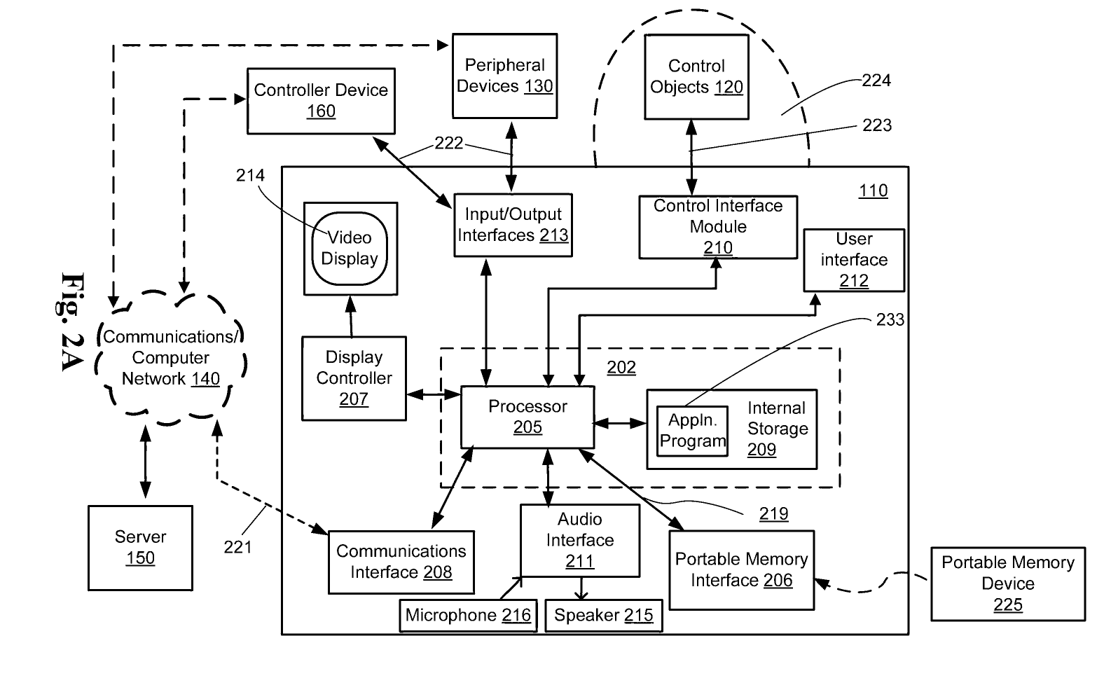

Thus, in arrangements where the control objects 120 are powered, the control interface module 210 also enables the device 110 to write information into the memory 309 (see FIG. 3B) of a control object 120.

In other arrangements where the control object 120 is unpowered, the control interface module 210 typically employs non-contact interactions based on recognition-based system (e.g., optical-based recognition system, 2D/3D object recognition system, and the like) or contact interactions to determine the identifiers of the unpowered control objects 120.

Accordingly, the size of the detection area 224 is dependent on the technology used for the interaction between the control interface module 210 and the control object 120.

In one arrangement, the control interface module 210 may be configured to detect the presence of the control object 120 with identifiable features such as an image or a complex shape. Although the identifiable features are neither unique nor considered to be an identifier capable of uniquely identifying the control object 120, the information characterised from the identifiable features (for example, by the processor 205 or the server 150) could be used to associate the detected control object 120 with a set of control information.

In the arrangement where the control object 120 includes identifiable features, the processor 205 or the server 150 is configured to characterise the identifiable features of a candidate control object 120. Such a characterisation may use a probability based algorithm, which could be a matching algorithm that compares previously stored binary templates of known control object(s) 120 against the identifiable features of the candidate control object 120. The probability based algorithm being an algorithm to compute a probability hypothesis. A determination of the stored template(s) that best match the identifiable features of the candidate control object 120 can then be made and control information provided. If multiple stored templates with probability results above a specified reliability or threshold value are discovered, the processor 205 or the server 150 may further select the template based on the probability result, utilize a sorting algorithm or randomly select one of the discovered stored templates, from which one or more control information may be deduced and acted upon. The stored templates can be stored in any one of the storage devices 209, 225, 309, and 409.

The processor 205 or server 150 selects one or more control information from the set of control information using for example the sorting algorithm. The sorting algorithm being an algorithm to rank the results in a certain order usable by the device 110, allowing the processor 205 or server 150 to evaluate and infer the control information that best suits the characterised identifiable features. Although the processor 205 or the server 150 is described to perform the characterisation of the identification features, the processor performing such characterisation can be located in devices other than the device 110 or the server 150.

Furthermore, if the processor 205 or the server 150 determines that the best probability result of a candidate control object 120 is below a threshold then: (1) no such control information results may be provided, or (2) the candidate control object 120 is deemed not to be a valid control object 120 and subsequently either ignored, no action taken or another pre-defined action initiated such as playing an error sound.

Furthermore, additional stored templates may be provided for example by the controller device 160. This would allow a new or previously uncharacterised control object to be added to the available stored templates and provide a means for any object to be associated with the control information. In one example, a parent takes a photo of an object with an app on a device. The device 110 can then characterise identifiable features from the photo, associate the identifiable features with control information (for example, playing back a movie) and store those identifiable features mapped as a binary template on the server 150 associated with the control information. Later, a candidate control object 120 with identifiable features is detected by the entertainment media device 110 then compared to the list of stored templates on the server 150. If no relevant template is found, then no such control information is provided if the candidate control object 120 is not the aforementioned object with the stored identifiable features template. If, however a suitable match is determined by the server 150 or the processor 205, relevant control information (in this case playing back a movie) is provided and the control information is performed by the relevant device (e.g., 110 or 130).

Direction of movement of the control objects 120 within the detection area 224 may also be used as an additional control parameter of the device 110. The direction of movement of the control objects 120 within the detection area 224 can be determined using different sensors that are incorporated into the control interface module 210. For example, the control object 120 is a NFC system and the control interface module 210 has a 2D/3D object recognition system and a NFC identification system. When the control object 120 is placed in the detection area 224, then the NFC identification system of the control interface module 210 detects the control object 120 and retrieves an identifier of the control object 120. At the same time, the 2D/3D object recognition system detects whether the control object 120 has been moved in a particular manner to trigger further control information of the device 110. For example, if the 2D/3D object recognition system detects an upward movement relative to the 2D/3D object recognition system's point of view, then the 2D/3D object recognition system associates the upward movement with increasing the audio volume of the device 110. In another example, if the 2D/3D object recognition system detects a sideway movement relative to the 2D/3D object recognition system's point of view, then the 2D/3D object recognition system associates the sideway movements of the control object 120 with fast forward or rewind of the media content playback.

In another arrangement, a NFC reader and an IR gesture sensor are incorporated into the control interface module 210. The NFC reader identifies the identifier and control information associated with the control object 120, while the IR gesture sensor(s) detect the relative location of the control object 120 within the detection area 224. For example, after the NFC reader detects the presence of the control object 120 within the detection area 224, the control interface module 210 enables the IR gesture sensors to periodically determine the relative location of the control object 120 within the detection area 224. Such polling of the location of the control object 120 enables the relative the movement of the control object 120 to be determined.

In another arrangement, a user's voice can also be used as an additional control parameter. For example, a user's voice could be pre-recorded so that a recorded voice (e.g., loud voice, the word “volume up”, etc.) is associated with increasing volume of the device 110, while another voice (e.g., softer voice, the word “volume down”, etc.) is associated with decreasing volume of the device 110. When a control object 120 is within the detection area 224, the device 110 is enabled to receive the user's voice which could then be used to increase or decrease the volume of the device 110.

The data being transmitted or received by the control interface module 210, the input/output interfaces 213, and the communications interface 208 may be encrypted to prevent unauthorized access to the transmitted data by third parties. As would be appreciated by a person skilled in the art, any data being transmitted by any of the communication channels in the system 100 may be encrypted.

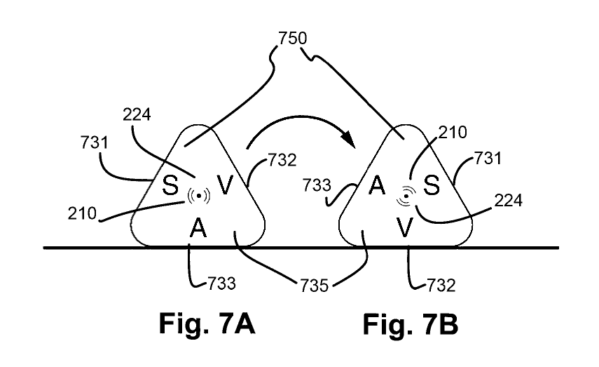

The device 110 may also include sensors (not shown) such as accelerometer, gyroscope, magnetometer, proximity sensor, gesture sensors, and the like to provide further functionality to the device 110. One example of such further functionality is shown in FIGS. 7A and 7B.

The components 206 to 213 typically communicate with the processor 205 via an interconnected bus (not shown) to enable the processor 205 to transmit and receive signals from the components 206 to 213.

The methods described hereinafter may be implemented using the embedded controller 202, where the processes of FIG. 5 may be implemented as one or more software application programs 233 executable within the embedded controller 202. The entertainment media device 110 of FIG. 2A implements the described methods. In particular, with reference to FIG. 2B, the steps of the described methods are effected by instructions in the software 233 that are carried out within the controller 202. The software instructions may be formed as one or more code modules, each for performing one or more particular tasks. The software may also be divided into two separate parts, in which a first part and the corresponding code modules performs the described methods and a second part and the corresponding code modules manage a user interface between the first part and the user.

The software 233 of the embedded controller 202 is typically stored in the non-volatile ROM 260 of the internal storage module 209. The software 233 stored in the ROM 260 can be updated when required from a computer readable medium. The software 233 can be loaded into and executed by the processor 205. In some instances, the processor 205 may execute software instructions that are located in RAM 270. Software instructions may be loaded into the RAM 270 by the processor 205 initiating a copy of one or more code modules from ROM 260 into RAM 270. Alternatively, the software instructions of one or more code modules may be pre-installed in a non-volatile region of RAM 270 by a manufacturer. After one or more code modules have been located in RAM 270, the processor 205 may execute software instructions of the one or more code modules.

The application program 233 is typically pre-installed and stored in the ROM 260 by a manufacturer, prior to distribution of the entertainment media device 110. However, in some instances, the application programs 233 may be supplied to the user encoded on one or more CD-ROM (not shown) and read via the portable memory interface 206 of FIG. 2A prior to storage in the internal storage module 209 or in the portable memory 225. In another alternative, the software application program 233 may be read by the processor 205 from the network 220, or loaded into the controller 202 or the portable storage medium 225 from other computer readable media. Computer readable storage media refers to any non-transitory tangible storage medium that participates in providing instructions and/or data to the controller 202 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 110. Examples of transitory or non-tangible computer readable transmission media that may also participate in the provision of software, application programs, instructions and/or data to the device 110 include radio or infra-red transmission channels (such as the connection 221) as well as a network connection to another computer or networked device, and the Internet or Intranets including e-mail transmissions and information recorded on Websites and the like. A computer readable medium having such software or computer program recorded on it is a computer program product.

The second part of the application programs 233 and the corresponding code modules mentioned above may be executed to implement one or more graphical user interfaces (GUIs) to be rendered or otherwise represented upon the display 214 of FIG. 2A. Through interaction with the control objects 120, the user interface 212 and/or manipulation of a user input device (e.g., the keypad) via the user input/output interface 213, a user of the device 110 and the application programs 233 may manipulate the interface in a functionally adaptable manner to provide controlling commands and/or input to the applications associated with the GUI(s).

FIG. 2B illustrates in detail the embedded controller 202 having the processor 205 for executing the application programs 233 and the internal storage 209. The internal storage 209 comprises read only memory (ROM) 260 and random access memory (RAM) 270. The processor 205 is able to execute the application programs 233 stored in one or both of the connected memories 260 and 270. When the entertainment media device 110 is initially powered up, a system program resident in the ROM 260 is executed. The application program 233 permanently stored in the ROM 260 is sometimes referred to as “firmware”. Execution of the firmware by the processor 205 may fulfil various functions, including processor management, memory management, device management, storage management and user interface.

The processor 205 typically includes a number of functional modules including a control unit (CU) 251, an arithmetic logic unit (ALU) 252, a digital signal processor (DSP) 253 and a local or internal memory comprising a set of registers 254 which typically contain atomic data elements 256, 257, along with internal buffer or cache memory 255. One or more internal buses 259 interconnect these functional modules. The processor 205 typically also has one or more interfaces 258 for communicating with external devices via system bus 281, using a connection 261.

The application program 233 includes a sequence of instructions 262 through 263 that may include conditional branch and loop instructions. The program 233 may also include data, which is used in execution of the program 233. This data may be stored as part of the instruction or in a separate location 264 within the ROM 260 or RAM 270.

In general, the processor 205 is given a set of instructions, which are executed therein. This set of instructions may be organised into blocks, which perform specific tasks or handle specific events that occur in the entertainment media device 110. Typically, the application program 233 waits for events (e.g., detection of the presence of the control object 120 within the detection area 224 of the control interface module 210) and subsequently executes the block of code associated with that event. Events are triggered in response to a user placing the control objects 120 within the detection area of the control interface module 210. Alternatively, events could also be triggered via the user input devices connected to the input/output interfaces 213 of FIG. 2A, as detected by the processor 205. Events may also be triggered in response to the sensors in the entertainment media device 110.

The execution of a set of the instructions may require numeric variables to be read and modified. Such numeric variables are stored in the RAM 270. The disclosed method uses input variables 271 that are stored in known locations 272, 273 in the memory 270. The input variables 271 are processed to produce output variables 277 that are stored in known locations 278, 279 in the memory 270. Intermediate variables 274 may be stored in additional memory locations in locations 275, 276 of the memory 270. Alternatively, some intermediate variables may only exist in the registers 254 of the processor 205.

The execution of a sequence of instructions is achieved in the processor 205 by repeated application of a fetch-execute cycle. The control unit 251 of the processor 205 maintains a register called the program counter, which contains the address in ROM 260 or RAM 270 of the next instruction to be executed. At the start of the fetch execute cycle, the contents of the memory address indexed by the program counter is loaded into the control unit 251. The instruction thus loaded controls the subsequent operation of the processor 205, causing for example, data to be loaded from ROM memory 260 into processor registers 254, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 233, and is performed by repeated execution of a fetch-execute cycle in the processor 205 or similar programmatic operation of other independent processor blocks in the entertainment media device 110.

### Example Structures of the Entertainment Media Device 110

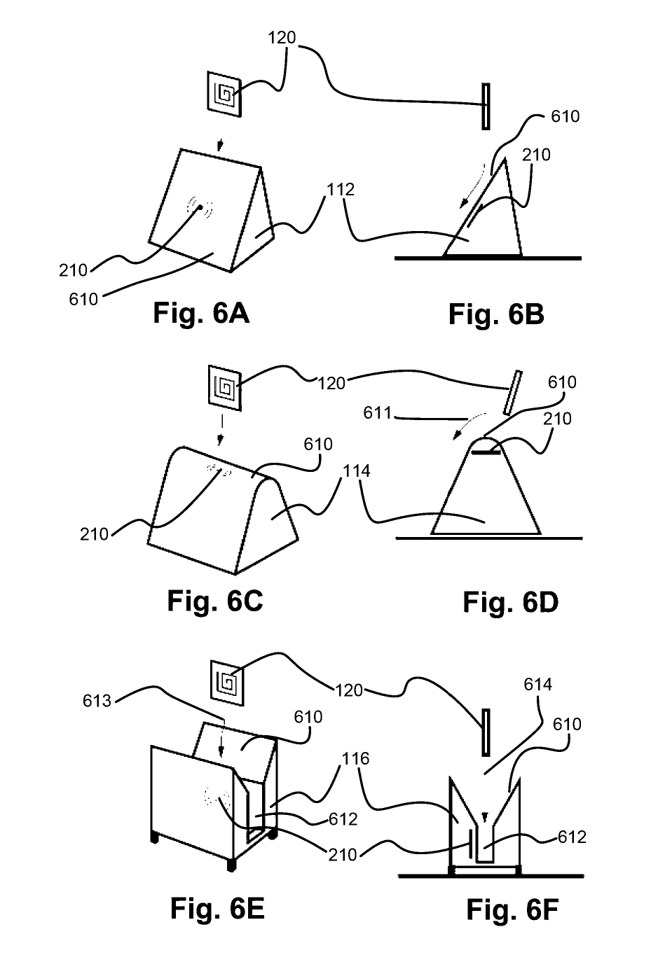

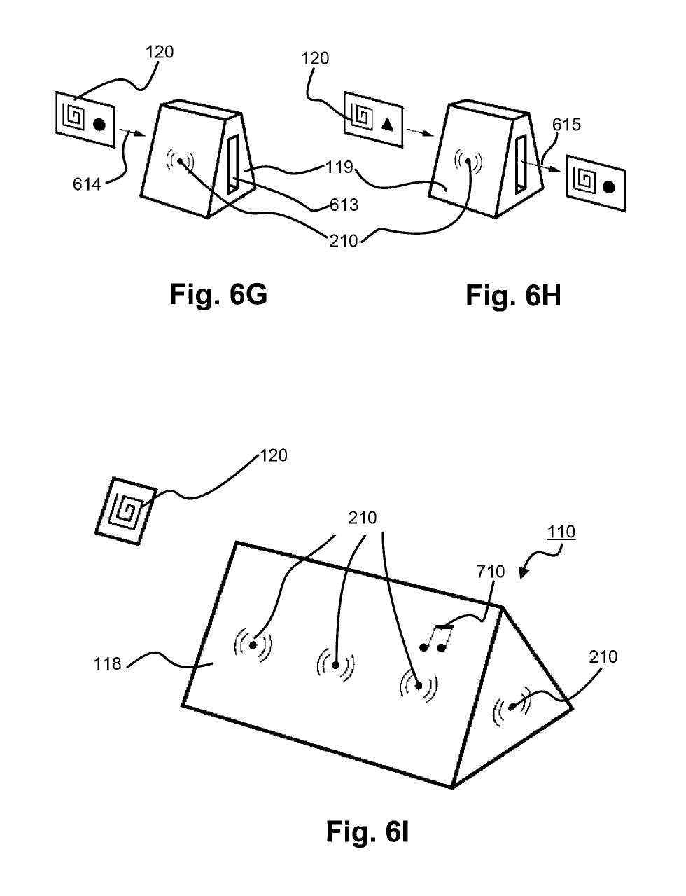

FIGS. 6A and 6B show a perspective view and a side view, respectively, of an example structure 112 of the device 110. The structure 112 comprises a detection area 610, which is an inclined surface area to prevent stacking of the control objects 120 atop the detection area 610. That is, the surface of the detection area is not in a plane that is parallel with the surface of the base of the device 110. In this particular example, the angle between the surface of the detection area and the surface of the base is substantially angled (e.g., more than 35 degrees) to allow a control object 120 to be removed from the surface of the detection area 610. The control interface module 210 is positioned behind the detection area 610 to detect and read the identifiers of the control objects 120 that are being placed on the detection area 610.

When the control object 120 is positioned on the detection area 610, the control object 120 cannot be left atop the detection area 610 to ensure that the control interface module 210 detects and reads the identifier of the control object 120 once. Further, preventing the control objects 120 from being stacked atop the detection area 610 also avoids the control interface module 210 from repeatedly reading the control objects 120. The design of the detection area 610 also assists a child using the device 110 to identify which control object 120 is interacting with the device 110, as the control objects 120 cannot be left atop the detection area 610.

FIGS. 6C and 6D show a perspective view and a side view, respectively, of another example structure 114 of the device 110 where the detection area 610 has a rounded or pointed surface area, behind which the control interface module 210 is positioned. When the control objects 120 are placed on the detection area 610, the control objects 120 are unable to balance on the detection area 610 and slide off the detection area by following the arrow 611. Thus, the control objects 120 are automatically removed from the detection area 610 due to the configuration of the detection area 610.

FIGS. 6E and 6F show a perspective view and a side view, respectively, of another example structure 116 of the device 110 where the detection area 610 has inclined surfaces to funnel the control objects 120 into a slot or channel 612, behind which the control interface module 210 is positioned. The slot or channel 612 also has an inclined surface toward one or both of the open ends to direct any control objects 120, which has entered the slot or channel 612, to either of the open ends. The control objects 120 thus travel through either a path 613 on any of the inclined surfaces 610 or a path 614 to enter the slot or channel 612 and past the control interface module 210 before exiting the device 110.

FIGS. 6G and 6H show perspective views of another example structure 119 of the device 110 where a slot or channel 613, in which the control interface module 210 is positioned, is built into the structure 119. The slot or channel 613 enables a first control object 120 to be placed into the channel 613. To remove the first control object 120, a second control object 120 is inserted into the channel 613 to remove the first control object 120 and at the same time enable the device 110 to detect the second control object 120.

In an alternative arrangement, the slot or channel 613 may also have an inclined surface toward one or both of the open ends to direct any control objects 120, which has entered the slot or channel 613, to either of the open ends. For example, the control object 120 travels through a path 614 to enter one end of the channel 613. The control interface module 210 of the structure 119 then detects and reads the identifier of the control object 120 while the control object is in the channel 613. The control object 120 then exits the channel 613 through the other end of the channel 613 via a path 615.

FIG. 61 shows another example structure 118 of the device 110 having a plurality of control interface modules 210. In the example structure 118, the rightmost control interface modules 210 is visually identified by a display element 710 to indicate the relative position and function of the identified control interface module 210. The centre and leftmost control interface modules 210 could also be identified with such a visual indication. In another arrangement, the display element 710 may be updateable depending on the control information associated with the visually identified control interface module 210. For example, if the control information is to play a video, the visual indication may be changed to a video icon.

Control interface modules 210 positioned at different locations could be configured to read different control information. For example, a control object 120 detected by the control interface module 210 at the centre of the structure 118 causes the device to play music, whereas the same control object 120 when detected by the control interface module 210 at the side of the structure 118 causes the device to play video. Therefore, multiple control interface modules 210 may be provided on the device 110, where each control interface module 210 causes the device 110 to interact with a single control object 120 in a different manner by playing different media. That is, different media may be played for a particular control object 120 dependent on the location of a control interface module 210 on the device 110.

FIGS. 7A and 7B show an example structure 750 having a plurality of surfaces 731, 732, 733, and 735. The surfaces 731, 732, and 733 are respectively attributed to respective modes S, A, and V (as indicated in FIGS. 7A and 7B). The modes S, A, and V are attributed to the modes Sound, Accessories, and Video respectively. The surface 735 has a control interface module 210 so that the detection area 224 is located on the surface 735.

FIG. 7A shows the structure 750 with the surface 733 supporting the structure 750, while FIG. 7B shows the structure 750 flipped to another position so that the surface 732 is supporting the structure 750. An accelerometer in-built in the device 110 enables the processor 205 to determine the orientation of the device 110.

When the surface 733 is supporting the structure 750 (e.g., the surface 733 is placed on the floor), the accelerometer in the device 110 sends a signal to the processor 205, which in turn determines that the A mode associated with the surface 733 is to be deactivated and change the operational state of the control interface module 210 located on the surface 735. Thus, the mode of the device 110 can be changed by changing the orientation of the device 110.

### Interaction Between the Entertainment Media Device 110 and the Control Object 120

When the control objects 120 are placed within the detection area of the control interface module 210, there may be issues relating to collision avoidance and repeated scans. Particularly, for a child who operates and interacts with toys in a different manner than adults. Therefore the device 110 requires specific operations in order to facilitate these nuances.

During media content playback or during repeated scans of a control object 120, the application program 233 provides operational instructions to the processor 205 to enable interactions between the device 110 and the control objects 120. Some examples of the operational instructions are as follows:

1) The processor 205 may be configured to pause playback of media content when the same control object 120 is placed on the detection area 224. The processor 205 may be configured to ignore other control objects 120 when media content is being played back, and the processor 205 may also be configured to play back another media content dependent on the detected control object 120, if the device 110 is not playing any media content.
2) The processor 205 may be configured to ignore repeated placements of the same control object 120 on the detection area 224 while the device 110 is operating (e.g., a playback is in progress). However, placement of another control object 120 on the detection area 224 interrupts the operation (e.g., the in-progress playback) of the device 110 and starts a new operation of the device 110 (e.g., playback of a new media content).
3) The processor 205 may be configured to disable the control interface module 210 during playback of media content so that the media content can be played back in its entirety before performing other functions as determined by any subsequent placement of the control objects 120 in the detection area 224;
4) The processor 205 may be configured to detect, during playback (e.g., audio content), of a control object 120 and execute the related control information for connecting a peripheral device 130 (e.g., a speaker or a headphone) to the device 110 so that the audio is output by the speaker or the headphone. This operation enables uninterrupted playback of the audio content while the processor 205 determines connection of the speaker to the device 110.
5) The processor 205 may be configured to execute different application programs 233 depending on usage patterns of the device 110. For example, the processor 205 may monitor and store usage patterns of the device 110 in the internal storage 209 and, when a control object 120 is placed in the detection area 224, the processor determines the typical usage of the device 110 at that particular time for that particular control object 120 and execute the typical operation of the device relevant to that particular time and control object. For example, the device 110 is typically used to play nursery rhymes between 2 pm and 3 pm in the afternoon by placing a triangle control object 120 in the detection area 224. In this example, if the triangle control object 120 is placed in the detection area at 2.10 pm, then the processor 205 determines that nursery rhymes are to be played based on the usage patterns of the device 110. In another example, the processor 205 may adjust how often a certain control object 120 is placed in the detection area 224 before that control object 120 is “locked out” for a given period.
6) The processor 205 may be configured to initiate a recording feature of the device 110, using an on-board microphone 216 or peripheral device 130. This operation may be initiated by the presence of a control object 120 within the detection area 224. Furthermore, the recording may subsequently be associated with a control object 120

### Control Objects 120

As described hereinbefore, the control objects 120 are objects having identifiers (e.g., shape, colour, electronic or printed identifiers, or the like) that are associated with control information (e.g., play, pause, increase or decrease volume, change mode of operation, etc.) of the device 110. When the control objects 120 are located in the detection area 224 of the device 110, the device 110 performs tasks associated with the control information associated with the identifiers of the control objects 120.

As discussed hereinbefore, the control objects 120 may also have identifiers that are associated with control information to effect an operation of the control objects 120, the peripheral device 130, the controller device 160, and the server 150.

The control objects 120 may take the form of any object such as a card, a toy, an instrument, a figurine, and the like.

The control objects 120 may be specifically shaped to correspond to control information associated with the control objects 120. In one example, a control object 120 having a triangle shape has control information for enabling the device 110 to play media content. In another example, a control object 120 having a square shape has control information for stopping the device 110 from playing media content.

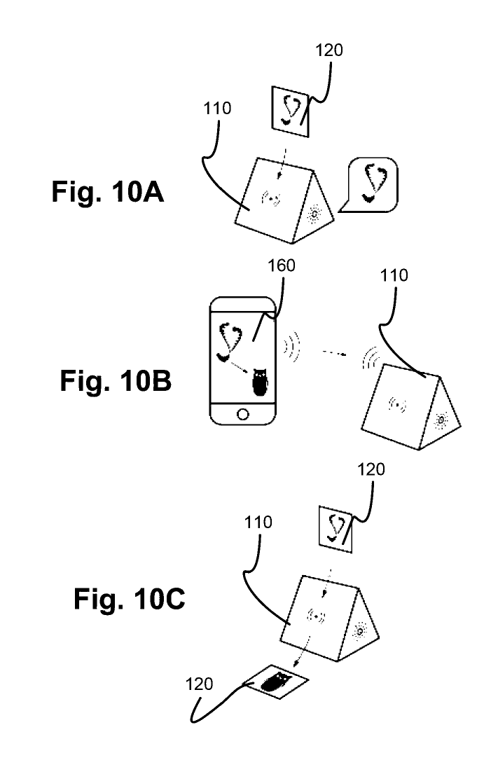

Each of the control objects 120 may display the associated control information. For example, as shown in FIG. 10A, for a control object 120 having control information for the device 110 to play a bird noise, that control object 120 may have a printed media 350 (see FIG. 3A) displaying a picture of a bird, may be shaped like a bird, may have an electronic display (shown in FIG. 10C) showing a bird picture, and the like. The display element (such as the printed media 350 and the electronic display) is updateable to represent the control information associated with the control objects 120, as shown in FIG. 10C. Further, the electronic display may be a LCD, e-ink, and the like. The updating of the display of the control object 120 will be described in detail in relation to FIGS. 10A to 10C.

The control object 120 may be powered or unpowered. Examples of powered control objects 120 include Near Field Communication (NFC) enabled control objects, Radio Frequency Identification (RFID) enabled control objects, and the like. Powered control objects 120 include active (e.g., Wi-Fi, Bluetooth, etc.) and passive (e.g., RFID, NFC, etc.) wireless communication methods. Examples of unpowered control objects 120 include shaped control objects, coloured control objects, and the like.

The control objects 120 are detectable by the device 110 and, in response to the device 110 detecting the presence of the control objects 120, the device 110 determines the identifiers of the control objects 120 and the control information associated with the determined identifiers. The device 110 then performs the function of the determined control information.

For example, an unpowered control object 120A is in the form of a triangle shape, which is also the identifier of the unpowered control object 120A. The triangle shape (i.e., identifier) is associated with control information to instruct the device 110 to start playing a first piece of audio content. When the control object 120A is placed in the detection area 224 of the device 110, the device 110 detects the presence of the control object 120A and determines that the identifier of the control object 120A is a triangle shape. The device 110 then determines control information (e.g., plays the first piece of audio content) associated with the triangle shape and plays the first piece of audio content.

In another example, a powered control object 120B has an electronic identifier that can be transmitted to the device 110 using NFC, when the control object 120B is in the detection area 224 of the device 110. The electronic identifier is associated with control information for the device 110 to pause the playing of audio content. When the control object 120B is brought into the detection area 224, the control interface module 210 of the device 110 detects the presence of the control object 120B and communicates with the control object 120B via NFC to receive the electronic identifier of the control object 120B. The processor 205, under the instructions of the application programs 233, then determines the control information (e.g., pause audio content) associated with the electronic identifier and executes the control information.

Accordingly, other control objects 120C, . . . , 120N may have various types of identifiers that are associated with other control information for the device 110. Such control of the device 110 by the control objects 120 enables simple and intuitive operation of the toy that are suitable for younger children.

The identifier of the control objects 120 may be associated with control information for controlling the device 110 in a number of different ways. For example, the control information for the device 110 may depend on the current state of the device 110, media type being played, previous interactions, and the like. In one example, the control information is used by the device 110 to play media content if the device 110 is not currently playing any media content, and by the device 110 to cease playing media content if the device 110 is currently playing media content.

### An Example of a Structure of a Control Object 120

FIG. 3A illustrates an example structure of the control object 120 comprising a housing 351 with recesses 353, a tag 352, and a printed media 350. The recesses 353 are formed in the housing 351 to house the printed media 350. The control object 120 illustrated in FIG. 3A is a powered control object 120.

The tag 352 shown in FIG. 3A is a RFID or NFC tag that is capable of communicating with the control interface module 210. Although the tag 352 is shown in FIG. 3A to be embedded within the housing 351, the tag 352 can alternatively be in the form of a sticker that is removably attached to the housing 351. One alternative arrangement of the control object 120 is a fridge magnet.

The printed media 350 is a marking or display to indicate the function to be performed by the device 110 when the control object 120 is brought within the detection area of the control interface module 210. The printed media 350 is securely placed in one of the recesses 353 such that the surface of the printed media 350 is flush with the housing 351 so that a child may find it difficult to remove the printed media 150 due to the child's limited dexterity. The printed media 350 also has a similar shape to the recesses 353 to further reduce the chance of the printed media 350 being removed by a child, thus mitigating a potential choking hazard.

For example, the printed media 350 may have a picture of a bird if the control information associated with the control object 120 is for the device 110 to play a bird noise.

In one arrangement of the system 100, an adult may wish to re-record the control object 120 to associate the control object 120 with different control information. For example, the control information can be amended from playing a bird noise to playing a dog noise. The adult can then remove the printed media 350 with the bird image with another print media 350 having an image of a dog.

The housing 351 may be constructed from wood, plastic, metals and the like that allow radio frequency signals to pass without interference, enabling wireless communication between the tag 352 and the control interface module 210. The housing 351 may also be in the form of figurines, soft toys, packs of numbers, cards and the like. Further, the housing 351 may be in different colours.

FIG. 3B shows a schematic block diagram of the tag 352 including an embedded controller 302, communications interface 308, and a power module 310.

As seen in FIG. 3B, the controller 302 has a processing unit (or processor) 305 which is bi-directionally coupled to an internal storage module 309. The functionality of the controller 302 is similar to the controller 202 of the device 110, while the functionality of the storage module 309 is similar to the storage module 209 of the device 110. The internal storage 309 also stores the identifier of the tag 352.

The communications interface 308 interacts with the control interface module 210 to enable communications between the tag 352 and the device 110.

The power module 310 comprises a power storage module (not shown) and associated power harvesting circuitry (not shown). For example, when the communication interface 308 receives radio frequency signals from the control interface module 210, the electrical power generated from the received radio frequency signals is transmitted to the power harvesting circuitry, which in turn powers up the power storage module and the controller 302. The power storage module stores the harvested power to enable the controller 302 to transmit radio frequency signal in response to the radio frequency signals received from the control interface module 210.

The communications interface 308 also transmits the received radio frequency signals to the processor 305, which in turn executes the application program 333 in the internal storage 309, to process the received radio frequency signals. The processor 305, executing the application program 333, then responds to the received radio frequency signals by sending, via the communication interface 308, a response radio frequency signals (e.g., an identifier of the tag 352, etc.).

If the control object 120 has a display (e.g., LCD, e-ink, etc.), the processor 305 also updates the display. For example, the display may be updated when power is harvested by the power module 310 and communication provided via the control interface module 310 instructs the control object 120 to update the display. While the control object 120 is in the detection area 224, the control interface module 210 may provide control information to the control object 120 to change the image to be displayed on the display element.

### Peripheral Device 130

As described hereinbefore, the peripheral devices 130 are devices that can be connected to the device 110 to put information into or get information out of the device 110.

Examples of peripheral devices include input devices (e.g., mouse, keyboards, microphones, musical instruments etc.) and output devices (displays, printers, loudspeakers, etc.). Input devices interact with or send data to the device 110, while output devices provide output to the user from the device 110. Some peripheral devices, such as touchscreens, play mats, interactive toys, and the like, can be used both as input and output devices.

In one arrangement, a peripheral device 130 is wirelessly connected to the device 110 through a pairing arrangement so that a bond is formed between the device 110 and the paired device 130. Such a bond enables efficient data transfer between the peripheral device 130 and the device 110. Further, the bond enables the paired devices 110 and 130 to connect to each other in the future without repeating the requisite initial pairing process of confirming device identities. When desired, the device 110 can remove the bonding relationship. Further, the pairing arrangement may also use out-of-band pairing arrangement, where two different wireless communication methods (e.g., Bluetooth and NFC) enable pairing.

FIG. 4 illustrates a schematic block diagram of a general peripheral device 130 comprising an embedded controller 402, communications interface 408, a power module 410, and a special function module 412. As seen in FIG. 4, the controller 402 has a processing unit (or processor) 405 which is bi-directionally coupled to an internal storage module 409. The functionality of the controller 402 is similar to the controller 202 of the device 110, while the functionality of the storage module 409 is similar to the storage module 209 of the device 110.

The special function module 412 is configured for performing a special function specific to that peripheral device 130. For example, a peripheral device 130 configured for playing back audio content has speakers that is operable by the special function module 412 and the processor 405. In another example, the special function module 412 is configured to operate a microphone to receive audio for processing by the processor 405.

The communications interface 408 interacts with the communications interface 208 or the input/output interfaces 213, via the network 140 or the connection 222 respectively, to enable communications between the peripheral device 130 and the device 110.

The power module 410 comprises a power storage module (not shown) for providing electrical power to the controller 402 and the communications interface 408.

Examples of the peripheral devices 130 are as follows:

1) A remote output device (e.g., a speaker) for reproducing media content that the entertainment media device 110 is instructed to play back.
2) A remote output device (e.g., a TV dongle) that operates as a media bridge. For example, when the device 110 is instructed to play a video file, the device 110 sends the related video file to the TV dongle, which in turn transmits the video file to a TV. Thus, the TV displays the video file.
3) A remote output device (e.g., a TV dongle) that operates as a media bridge. For example, when the device 110 is instructed to play a video file, the device 110 instructs the remote output device to retrieve and playback a file from a storage location (e.g., a local storage or server), enabling the TV to display the video file.
4) A remote output device (e.g., a Smart TV with an application) to receive instructions from the device 110 to play a video file. Such a remote output device enhances sensory output of the device 110 to a child using the device 110. Such a remote output device may also be referred to as a streaming client (i.e., a device or software application implemented with a primary purpose of streaming digital content for display to a consumer).
5) A remote input device (e.g., a play mat) that is able to receive inputs from a user. The inputs are then transmitted to the device 110, which processes the input in order to perform certain actions. For example, when the play mat detects that a kid has stepped on the mat, the play mat sends a control signal to the device 110, which then displays the area of the mat on which the kid has stepped.
6) A remote device having a control interface module 210 so that the control objects 120 may be detected by the remote device. Such a remote device acts to extends the capability of the device 110 of interacting with the control objects 120.

In one arrangement, a control object 120 and a peripheral device 130 may be combined into one device to enable the functionality of both the control objects 120 and the peripheral devices 130. For example, a combined device has a microphone (e.g., in-built peripheral device 130) and an in-built control object 120. When the combined device is brought into the vicinity of the device 110, the device 110 determines the identifier of the control object 120 in the combined device. The identifier is associated with control information for activating the microphone in the combined device and pairing the microphone to the device 110. The device 110 accordingly sends a control signal to the combined device to activate the microphone and pair the microphone to the device 110.

Further, the identifier of the example combined device may also be associated with control information to put the device 110 into a karaoke mode after the microphone has been paired with the device 110. Thus, after the microphone has been paired with the device 110, the device 110 executes the control information to put the device 110 into the karaoke mode.

As can be appreciated, the combined device having both a control object 120 and a peripheral device 130 provides a simple interaction for a child, thereby enabling a single scanning of the control object 120 to effect multiple control operations on the device 110.

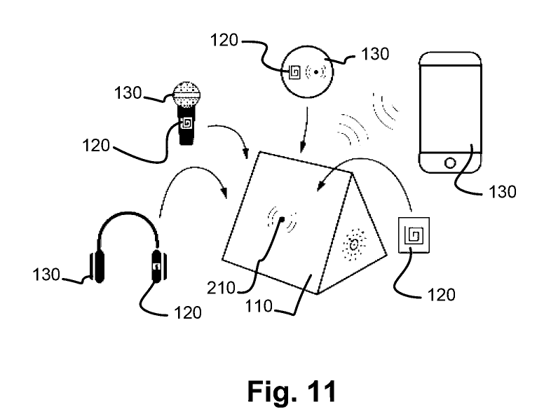

Further, multiple combination devices may be scanned and operation of each layered to achieve an outcome. For example, each combination device may represent a different instrument and configured to be used together in a band arrangement. This is described in more detail herein with reference to FIG. 11.

### Controller Device 160

The controller device 160 includes corresponding software applications to communicate with the device 110 in order to control (e.g., send control signals, receive status of the device 110, etc.) the device 110. Examples of controller device 160 that may have such software applications include a smartphone, a tablet device, a general purpose computer, a dedicated remote control unit and the like. If the device 110 is a toy, such a controller device 160 is typically operated by a parent to enhance or restrict functionality of the toy. The controller device 160 with such software applications can control the device 110 to start or stop playing video/audio files, configure the responsiveness of a control object 120, configure access rights to a media, change the mode of operation of the device 110 and the like.

The controller device 160 may also provide instructions to the device 110 to enable or disable certain functionality, such as to allow/disallow playback of specific types of media, adjust the volume of the device 110, and the like.

The controller device 160 may also change the control information associated with identifiers of the control objects 120. For example, an identifier of a control object 120 may be associated with control information that instructs the device 110 to play a first media content. The controller device 160 may change the control information so that the device 110 plays a second media content. For example, the controller device 160 may create a Uniform Resource Identifier (URI), send the created URI to the device 110, which then sends the created URI to a control object 120, so that the URI is stored in the internal storage 309 of the control object 120.

The controller device 160 may also provide instructions to the device 110 to enable specific functionality depending on time of use and the like. For example, the controller may configure that only sleep time “nursery rhymes” are to be played during the times 6:00 pm and 10:00 pm.

The controller device 160 may be further configured to instruct a control object 120 to display a certain image if that control object 120 has a display element. The display may be initiated either directly by its own control interface module 210 or indirectly using the control interface module 210 of the device 110. An example of this functionality is shown in relation to FIGS. 10A to 10C.

A controller device may also be configured to directly access the control object with an associated control interface module 210 (Not shown in figure) and read from or write to the control object. This enables the reading, updating or creating of a new identifier or control information.

A controller device may also be configured to initiate a recording feature of the device 110, using an on-board microphone 216 or peripheral device 130. Furthermore the recorded content may subsequently be associated with a control object 120

### Control Information Associations

### Overview

As discussed hereinbefore, identifiers of the control objects 120 are associated with control information. The control information association between identifiers and control information may be stored in at least one of the control objects 120, the device 110, the server 150, the peripheral devices 130, and the docking module 180. Each aspect of this association (I.e. An identifier, a control information association and control information) may be stored together, or separate or a combination of each. Also, one or more aspects of the association may not be required. For example, an identifier may not be required if association provides sufficient information to link to control information. Collectively, this may be referred to as control information. By way of example, a typical implementation is described for each the identifier, control information association and control information.

### Examples of Identifier

Examples of identifiers that can be used for the control objects 120 are as follows:
1) A unique identifier (UID). An electronic identifier capable of uniquely identifying a control object 120. The UID may be stored in the internal storage 309 of the control object 120. The UID may be similar to a serial number, a data string, made up of numeric, alphabetic or alphanumeric characters, and the like.
2) A search term or keyword. An electronically stored string of characters stored in the internal storage 309 of the control object 120. When the control object 120 is placed within the detection area 224, the processor 205 of the device 110 retrieves the keyword(s), matches to control information and executes the control information.
3) A universally unique identifier (UUID). A UUID may be used to enable distributed systems 100 to uniquely identify control information without significant central coordination. A UUID can be configured as a 128-bit value and stored in the internal storage 309 of the control object 120. Furthermore, this may be generated dynamically by the control object 120 or provided externally such as via the device 110.
4) A physical property of the control object 120, such as shape, colour, electrical resistance and the like.
5) An optical readable property of the control object 120, such as a barcode, QR code and the like.

### Examples of a Control Information Association

Examples for a control information association are shown below.
1) A database. One method for associating control information with an identifier of a control object 120 is a relational database, where a “table” represents a “record” (i.e., control information of the device 110) association to a “field” (i.e., an identifier of a control object 120). The table can represent associations of: (i) one control function to one identifier; (ii) one control function to many identifiers; (iii) one identifier to many control function; and (iv) many control functions to many identifiers.
2) A Uniform Resource Identifier (URI). The URI may be generated, transferred to and stored in the internal storage 309 of the control object 120. Furthermore, a URI may enable a control object 120 to control the devices 110 of different systems 100 if stored within memory 309. For example, the controller device 160 creates the URI, sends the created URI to the device 110, which then sends the created URI to a control object 120, so that the URI is stored in the internal storage 309 of the control object 120.
3) A search algorithm. For example, a media file metadata information and corresponding lookup method. Such that, an identifier may enable a control object 120 to be associated with, for example, a specific musician via a search term or keyword(s).
4) An application programming interface (API). In another example, a software component may interface directly with another software component via a protocol. This API can be used to interface with, for example, a database, a storage location, a web based system and the like. The control information associated with the API can then be activated.
5) A link to a resource or list of resources. This links to control information that is external to the control object 120 and allows a control information association which is dynamic or externally changeable.

To further elaborate by example, a control information association may include a list of media content that is playable by the device 110. The list can be updated so that the operational response of the device 110 changes according to the updated list. Furthermore, a control object 120 and accompanying control information association may be configured to play from the list of random media content.

In another example, the device 110 may analyse and record historic operations of a control object(s) and determine a future or current operation of the control object. Accordingly, through this analysis of operations the control information association related to a control object 120 may be updated to provide a customized, recommended, random or new content to a child using the device 110 via a control object 120.

Control Information association may be updated remotely via server 150, device 110, controller device 160 or dynamically by the control object 120 itself.

In another example, a control object 120 may contain a number of different control information associations, which, through other means as described in this document, can provide a different contextual response, such as shown in FIGS. 61, 7A and 7B

### Examples of Control Information

The control information provides functionality of the device 110, the control object 120, and the peripheral device 130. Some examples of the control information include media playback, credential exchange, control parameter adjustment, control parameter creation, searches, gaming functions, electronic book content, etc.

Control object associations can be used to allow a control object when brought within the scan area to initiate, modify and/or adjust a plethora of functions, these functions may include:
1) Playing media content such as a sound, music or video live broadcasts or reading a file;
2) Pausing, playing, stopping, fast forwarding, rewind or track skipping of media content;
3) Modifying a functional parameter (e.g., volume or indication patterns of visual feedback) of the device 110;
4) Initiating or changing the functionality of the device 110. Such an initiation or change of functionality may differ depending on the operational state of the device 110;
5) Administer operations of the toy apparatus such as Locking the device 110 in a state of operation, Restricting access to certain features of the device 110, Enabling media content playback by the device 110 for a specified amount of time;
6) Initiate a recording feature of the device 110, using an on-board microphone 216 or peripheral device 130. Furthermore the recorded content may subsequently be associated with the control object 120
7) Controlling, enabling or pairing a peripheral device 130 associated with the device 110;

To further elaborate by example, the control information is stored in the internal storage 209 of the device 110, for access by the processor 205, in response to the control interface module 210 detecting the presence of a control object 120 and determining an identifier associated with the detected control object 120.

In another example, the control information is stored in the internal storage 309 of the control object 120, so that the control information can be transmitted together with the identifier to the device 110 when the control object 120 is brought within the detection area 224 of the device 110.

In another example, the control information is stored in the internal storage 409 (see FIG. 4) of the peripheral device 130. When the device 110 determines an identifier of a control object 120 that has been brought within the detection area of the control interface module 210, the processor 205 of the device 110 accesses the control information in the internal storage 409 to utilise the control information associated with the determined identifier.

In another example, the control information may be stored in either the device storage 209 of the device 110, internal storage 409 of a peripheral device 130 or the server 150. When the device 110 determines an identifier of a control object 120 that has been brought within the detection area of a control interface module 210, the processor 205 is configured to search each location in a sequence for the control information associated with the determined identifier. Furthermore, the processor 205 may be configured to search each location in a sequence for the control information directly from a control information association.

Further, still media or functionality associated control object 120 may expand or contract depending on predetermined criteria (e.g., the age of the child). If the child is young, media or functionality associated with the control object 120 may be reduced, for example, limited to a machines noise. As the child ages, the media associate with the control object 120 may expand in complexity, for example, including the name of the object emitting the noise, or allowing the association of the control object shape or colour with other educational games (e.g., find the colour red).

### Dynamic Associations

The associations between identifiers and control information can also be updatable. For example, the control information association allows for a device 110 to play back the latest version of certain media content, such as a TV series, albums from an artist, and the like. Thus, the control information association may be updated when a new version of the media content is available so that the latest version of the media content is played when the related control object 120 is placed in the detection area of the device 110.

Alternatively, the link to dynamic control information, such as changing media content, may allow a control object to play an increasing number of media files, such that a single control object 120 can be associated with an increasing number of files and instruct the device 110 or the peripheral device 130 to play any media content from the list of media files.

Typically, media content has a descriptive metadata detailing information (e.g., title, artist, album, track number, format, and the like) about the media content. One example for updating the playable media content (control information) is via a relational database or search algorithm which enables an association between a control object 120 with a changing media via this media metadata.

Further, the system may determine, catalogue and/or play back not only media content in its entirety but also fine grained segments of content within a block of media. e.g. a scene within a TV episode played by a certain character, a song within a movie, etc. That is, a portion of the media content (e.g., the audio content) may be playable by the entertainment media device.

This level of detailed access to media requires enhanced associations, searching and/or database capabilities. Fine grained storage, search capabilities and actions of a media file as a result of this information provides greater functionality. Various schemes may be used to allocate data to specific locations in a media file. For example, subtitle formats such as .srt or .sub may be used to provide text information related to a scene. A format such as Extensible Markup Language (XML) may be structured and associated with the media file to allow this fine grained access to media information and to provide intelligent actions accordingly. When additionally associated with a control object, this information can enhance a user's interaction with the media. For example; A control object may have a control information association to songs within a specified movie where repeated scans of this control object will reproduce only the songs from that specific movie.

### Storage of Media Content

Media content that can be played back by the device 110 is required to be stored and accessible by the device 110 in order to provide the media content to end users. Some examples of storing and providing such media content are as follows:

The media content can be stored within the internal storage 209 of the device 110 or the internal storage 309 (see FIG. 3B) of the control object 120. The media content may also be structured or controlled by a file system.

The media content can be stored on the server 150 or the peripheral devices 130. When the media content is requested by the device 110, the media content is streamed or transmitted from either the server 150 or the peripheral devices 130 via the network 140 to the device 110. The device 110 may also instruct a peripheral device 130 (e.g., a TV dongle) to play the media content.

The media content may additionally be associated with a user account when media content is created or retrieved or purchased or rented. Additionally, the associated user account may be used to validate that the media content is associated for use by a specified user and actions taken accordingly to enable, restrict or disable the media content.

The media content may additionally be validated using a Digital rights management (DRM) scheme. Additionally, the DRM scheme may be used to validate that the media content is associated for use by a specified user and actions taken accordingly to enable, restrict or disable the media content.

In one arrangement where NFC is used as a method of communication between the control interface module 210 and the control object 120, the identifier of the control object 120 is stored in one or more NFC Data Exchange Format (NDEF), which includes NDEF records and NDEF messages to store and exchange data. Further, the NDEF may also be used to store the associated control information, and associations between identifiers and control information. In such an arrangement where the identifier and the related control information are stored in the NDEF (which is stored in the internal storage 309 of the control object 120), the processor 205 of the device 110 would retrieve the identifier and control information from the internal storage 309 when the control object 120 is placed within the detection area 224.

In another arrangement, the control object 120 may store the identifier, the related control information, and the related media content, thereby enabling all data to be readily available on the control object 120. Thus, when the control object 120 is placed within the detection area 224, the processor 205 of the device 110 can quickly and easily obtain all data relating to that control object 120.

### Operation of the Entertainment Media Device 110

FIG. 5 is a flow diagram of a method 500 for operating the device 110 using the control objects 120.

The method 500 commences at step 510 where the device 110, using the control interface module 120, detects the presence of one of the control objects 120 within the detection area of the device 110. The control interface module 120, under the control of the processor 205 executing the application program 233, periodically examines the detection area for the presence of one of the control objects 120.

The control interface module 210 detects the presence of the control objects 120 as described above in relation to FIG. 2.

If the control interface module 120 does not detect the presence of one of the control objects 120 (NO), then the method 500 remains at step 510 to continue monitoring for the presence of one of the control objects 120.

If the control interface module 120 detects the presence of one of the control objects 120 (YES), then the method 500 proceeds to step 520.

At step 520, the control interface module 210, under the control of the processor 205 executing the application program 233, determines an identifier of the detected control object 120. If the control object 120 is passive, then the identifier of the passive control object 120 is determined by the control interface module 120 determining a parameter (e.g., shape, colour, etc.) of the passive control object 120.

If the control object 120 is active, the processor 205 sends a control signal to the processor 305, via the control interface module 210 and the communications interface 308. In response to receiving the control signal, the processor 305 retrieves the identifier of the control object 120 from the internal storage 409 and transmits the identifier to the processor 205 via the communications interface 308 and the control interface module 210.

The method 500 then proceeds to step 530.

At step 530, the processor 205 executing the application program 233 retrieves control information associated with the identifier. As described above, the control information may be stored in the internal storage 209 of the device 110, the server 150, the internal storage 309 of the control object 120, or the internal storage 409 of a peripheral device 130.

If the control information is stored in the internal storage 209 of the device 110, then the processor 205 accesses the internal storage 209 and retrieves and executes the relevant control information from the control information association, such as a database.

If the control information is stored in the internal storage of the server 150, then the processor 205 communicates with the server 150 via the network 140 to request access to the database. In response to the request, the server 150 transmits the control information from the database to the processor 205 or transmits the database stored in the internal storage of the server 150.

If the control information is stored in the internal storage 309 of the detected control object 120, the processor 205 communicates with the control object 120 via the control interface module 210 to request access to the database. In response to the request, the control object 120 transmits the control information from the database to the processor 205 or transmits the database stored in the internal storage 309 to the processor 205.

If the database is stored in the internal storage 409 of a peripheral device 130, then the processor 205 determines the identity of the peripheral device 130 that contains such a database. The processor 205 communicates with the peripheral device 130 via the network 140 or the input/output interfaces 213 to request access to the database. In response to the request, the peripheral device 130 transmits the control information from the database to the processor 205 or transmits the database stored in the internal storage 409 to the processor 205.

When the processor 205 has retrieved the related control information, the method 500 proceeds to step 540.

At step 540, the processor 205 executes the control information. For example, if the control information instructs the device 110 to play back media content, then the processor 205 accesses the media content and plays back the media content.

The method 500 then concludes.

Furthermore, it will be understood that control information association may be provided directly by the control object 120 while within the scan area. Thus the step of Retrieving control information 530 may proceed directly after detection of an object in the scan area 510.

Furthermore, the media may be provided directly by the control object 120, therefore skipping over steps 520 and 530.

### Remote Messaging System

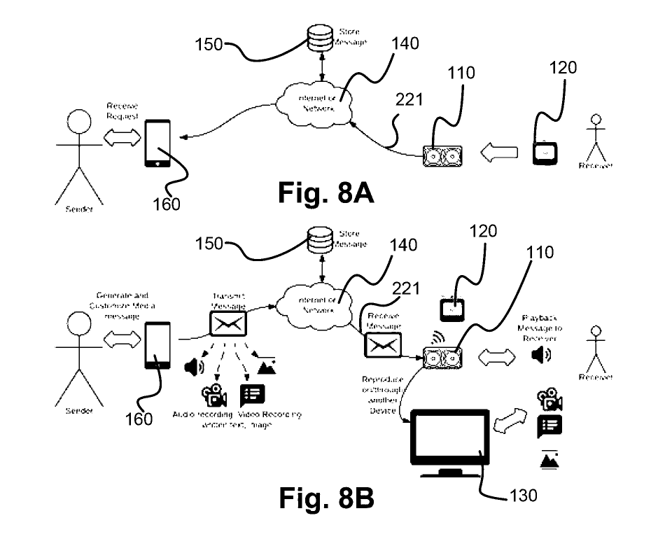

FIGS. 8A and 8B show the entertainment media system 100 being used as a remote messaging system. The device 110 is linked with a controller device 160 to enable communication between the two devices 110 and controller device 160.

FIG. 8B shows a message being sent from the controller device 160 to the device 110. A user (e.g., a parent) uses an interface on the controller device 160 to record a message (e.g., audio, video, or text based content) that is intended to be played back by the device 110. The controller device 160 then sends the recorded message from the communications interface 408 to the processor 205 of the device 110 via either the network 140 or the connection 222. The processor 205 then receives the recorded message via the communications interface 208 or the input/output interfaces 213 if the recorded message is sent via the network 140 or the connection 222 respectively. The processor 205 then disables the current media being played on the device 110 to play back the recorded message. If text has been inputted into the controller device 160, the controller device 160 may synthesize the input text into an audible output.

Alternatively, the message is streamed live from the controller device 160 to the device 110.

FIG. 8A shows a message being sent from the device 110 to the controller device 160. a user (e.g., a child) of the device 110 places a control object 120, which is related to recording a message to be sent to the controller device 160, within the detection area 224 of the control interface module 210. The control interface module 210 detects the presence of the control object 120 and the processor 205 retrieves the control information (which is to record a message and send the recorded message to the controller device 160) from the related database. The processor 205 then activates a microphone (e.g., in-built microphone 216, one of the peripheral devices 130, etc.) to record the response. Once the message is recorded, the processor 205 executes the next step of the control information, which is to send the recorded message to the controller device 160. The recorded message is delivered to the controller device 160 using the same path (e.g., either through the network 140 or the connection 222) as when receiving the recorded message from the controller device 160.

Alternatively, the device 110 receives the recorded messages from the controller device 160 and indicates (e.g., flashing lights) that recorded messages are available for listening on the device 110. To access the messages, the user places a control object 120 associated with accessing and playing back messages on the device 110. The control interface module 210 detects the presence of the control object 120 and the processor 205 retrieves the control information (which is to access the recorded message) from the related database. The processor 205 then activates a speaker (e.g., in-built speaker, one of the peripheral devices 130, etc.) to play back the recorded messages.

The user (e.g., a child) of the device 110 can also initiate communication to the controller device 160 by placing a control object 120 associated with recording a message onto the device 110 and sending the recorded message to the controller device 160. The control interface module 210 detects the presence of the control object 120 and the processor 205 retrieves the control information (which is to record a message and send the recorded message to the controller device 160) from the related database. The processor 205 then activates a microphone (e.g., in-built microphone, one of the peripheral devices 130, etc.) to record a message. Once the message is recorded, the processor 205 executes the next step of the control information, which is to send the recorded message to the controller device 160. As described above, the recorded message is delivered to the peripheral device 160 either through the network 140 or the connection 222.

When the controller device 160 receives the recorded message, the controller device 160 may vibrate, play a sound, flash LEDS, or combinations thereof, to notify the user of the controller device 160 of the incoming message.

### Remote Administration of the Entertainment Media Device 110

A second example relates to remote administration of the device 110, where the device 110 is being controlled by a controller device 160. Such a remote administration of the device 110 enables greater control and enhanced functionality of the device 110. In particular, when the device 110 is a toy, a parent can control the device 110 while, at the same time, there is no added complexity to the child's interactions with the toy 110. For example, non-essential functionality such as buttons or displays may be provided on the controller device 160 so that the device 110 does not have a user interface. In this way, the child is not able to interact with these functions.

Additionally, there may be compatibility issues between a control object 120 and the controller device 160 as there is no direct communication link between the control object 120 and the device 160. Therefore, the controller device 160 is enabled to use the control interface module 210 via the network 140 to write to, read or modify a control object 120. For example, associations between the identifiers of the control objects 120 and the control information, or media contents stored in the control objects 120 may be modified.

Additionally, remote administration of settings and personalization of the device 110 enable users (e.g., parents) to restrict access to the device 110. For example, users can restrict access to certain media content or certain functionality of the device 110 at certain times. Some examples include activating the device 110 from a low power state to normal operation mode, and enabling playback of video media content for a specified amount of time.

Controller devices 160 such as mobile phones may be incompatible with the technologies used or be capable of communicating with the control objects 120 directly. A control object 120 may be modified via the control interface module 210 under the control of the processor 205. Modified information includes the identifiers of the control object 120, associations between identifiers and control information, and the like.

Control objects 120 detected to be blank or not having correct identifier may be indicated on the controller device 160 to allow a user (e.g., a parent) of the controller device 160 to rectify the error.

The controller device 160 in this example may also receive a notification from the device 110 to enable recording interactions of a user (e.g., a child) with the device 110. Such a recording enables the user of the controller device 160 to share the interactions with family and friends. This recording may additionally be manually or automatically added to the users account and/or assigned to a control object 120 with accompanying identifier-control information associations.

### Remote Administration of the Control Object 120

FIGS. 10A to 10C show an example of the remote administration of the control object 120 by the controller device 160. FIG. 10A shows a control object 120 having a display (e.g., e-ink display) showing a bird as the identifier of the control object 120 is associated with control information to instruct the device 110 to play a bird noise.

The controller device 160 may also remotely change the media associated with the control objects 120. For example, the media associated with the control object 120 would be displayed on the controller device 160 by scanning the control object 120 over the controller device 160. The user may then reassign the media associated with the control object 120 so that next time the control object 120 is scanned the device 110 then plays the new media with which the control object 120 is associated.

FIG. 10B shows that the controller device 160 may for example change the operation of the device 110 so that the control object 120 causes the device 110 to have a different association with the control object 120. For example, the device 110 may play different media, e.g. an owl noise, instead of a different bird noise. At the same time, the controller device 160 may send control information to the device 110 to instruct the display of the control object 120 to display an image based on the new association, such as an owl. The controller device 160 sends the control data to change the operation of the device 110 via either the computer network 140 or the connection 222. Accordingly, the control information association storing the associations between identifiers and control information is updated.

FIG. 10C shows that when the control object 120 is placed in the detection area 224 of the device 110, then the display of the control object 120 is changed to an owl in accordance with the control information sent by the controller device 160. A bird noise (such as chirping) may be played one last time, subsequent placement of the control object 120 within the detection area 224 would then result in an owl noise (such as hooting) being played by the device 110 as opposed to the chirping bird noise

In one arrangement, the control information associated with the identifier of the control object is for the device 110 to play a list of different noises, such that a different noise is played corresponding to a different image for each subsequent placement of the control object 120. In this arrangement, when the control object 120 is placed within the detection area 224, a noise associated with current image is played, the display element of the control object 120 is updated and the control information association and the control information is updated. Subsequent scans of the control object 120 when within the detection area 224 will repeat this cycle

Furthermore, the control information association and control information may be replaced automatically each time the control object is within the vicinity of the scan area to other related or unrelated control information.

It will be understood that the sounds and images used in the example above may be replaced with other sounds and images and other control information, such as media content or instructions.

### Remote Scanner

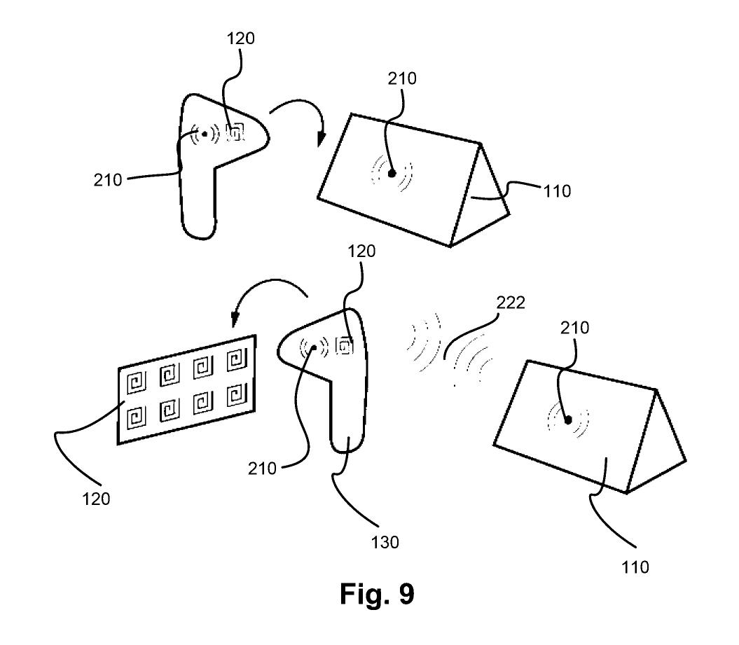

FIG. 9 shows a combined device 130 (configured as a control object detector) having a control object 120 (e.g., similar to the tag 352 discussed in relation to FIG. 3A) and a control interface module 210. The control object 120 of the combined device 130 has an electronic identifier that is associated with control information for the device 110 to pair the combined device 130 with the device 110 when the combined device 130 is placed in the detection area 224 of the device 110.

Accordingly, when the combined device 130 is placed in the detection area of the device 110, the controller interface module 210 of the device 110 detects the presence of the combined device 130. In response to the detection, the control interface module 210 of the device 110 retrieves an identifier from the control object 120 of the combined device 130, retrieves control information associated with the identifier from a database (for example, as described hereinbefore) and performs the associated control function (e.g., to pair the combined device 130 with the device 110).

After the combined device 130 has been paired with the device 110, the combined device 130, through its in-built control interface module 210, is enabled to perform the functionality of the control interface module 210 of the device 110. When a user places the control interface module 210 of the combined device 130 near any of the control objects 120, the control interface module 210 of the combined device 130 detects the presence of the control objects 120 and retrieves the identifiers of the detected control objects 120. The retrieved identifiers are then transmitted back to the device 110 via the connection 222, so that the processor 205 can execute the control information (e.g., playing back media content) related to the retrieved identifiers.

Such a combined device 130 enables easy, accurate and convenient detection of the control objects 120, such as multiple control objects in a book, for example. One example application of such a combined device 130 is a waterproof bath toy.

### Linking Multiple Peripheral Devices 130

FIG. 11 shows the linking of multiple peripheral devices 130 to the device 110. Each peripheral device 130 (configured as different devices, such as a guitar, a flute, a microphone, etc.) is a combined device having an identifier which is associated with pairing the combined device with the device 110 and executing the application programs 233 by the processor 205 to facilitate the operation of the combined device.

Accordingly, when the combined device is placed in the detection area of the device 110, the controller interface module 210 of the device 110 detects the presence of the combined device. In response to the detection, the control interface module of the device 110 retrieves an identifier from the tag of the combined device, retrieves control information associated with the identifier from a database (as described hereinbefore) and performs the associated control function (e.g., to pair the combined device with the device 110 and executing the application programs 233 by the processor 205). Therefore, multiple combined devices can be easily and quickly paired with the device 110 to be used simultaneously. This example application is particularly useful when the device 110 is a toy to enable young children to perform the pairing function easily.

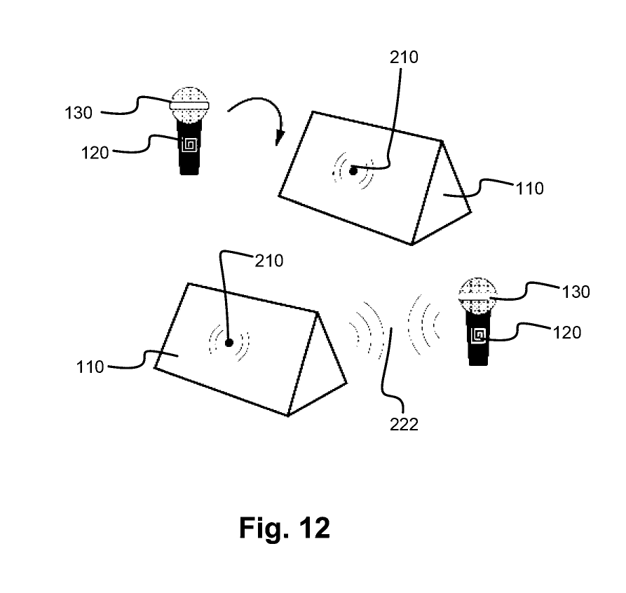

FIG. 12 shows the pairing process between a peripheral device 130 and the device 110. When the control interface module 210 detects the control object 120 in the device 130, the processor 205 of the device 110 identifies the associated control information, which is to establish a link between the device 130 and load required programs associated with said device 130.

Before the peripheral device 130 is paired with the device 110, the combined device 130 may be initially configured to be in a low power state (sleep mode), where only components necessary for receiving NFC signals are powered. The control information associated with the identifier of the control object 120 in the combined device 130 also includes control function for the device 110 to send a control signal to the combined device to put the combined device in operational mode (i.e., the combined device is fully powered up to provide full functionality).

For example, a combined device 130 having a microphone is powered up to enable long distance/higher bandwidth RF link with the device 110.

In another example, the control object 120 in the combined device 130 may use passive wireless communication Standard and harvest power when receiving radio frequency signals. When the combined device 130 is placed in vicinity of the detection area 224 of the device 110, the combined device harvests power from the radio frequency signals received from the control interface module 210. The harvested power enables additional functions of the combined device. Such a feature enables the combined device to draw no power at all until activated via the radio frequency link, thereby extending operation lifetime of the combined device and reducing size of power storage requirements.

Further, during the pairing process, there may be further control information associated with the control object 120 to change the operation state of the device 110. For example, when a microphone 130 is placed within the detection area 224, the control information instructs the device 110 to activate karaoke mode and at the same time enabling the microphone 130 to be linked to the device 110.

In an example where the peripheral device 130 is a headphone, the associated control information may be to disable audio playback to the speaker 215 and enable audio playback to the headphone, during the pairing process.

It will be appreciated that pairing process is applicable to all kinds of peripheral devices, for example, musical instruments, microphones, projectors, play matt, projector, etc.

When the peripheral devices 130 are linked to the device 110, a notification may also be sent to the controller device 160. The parent may then record the child's interactions with the peripheral device 130 via the controller device 160 to later share with family and friends. This recording may additionally be added, either manually or automatically, to the user's account and/or assigned to a control object 120 with accompanying control object associations, if desired, to allow for simplified sharing with family and friends.

Interactivity with a Peripheral Device

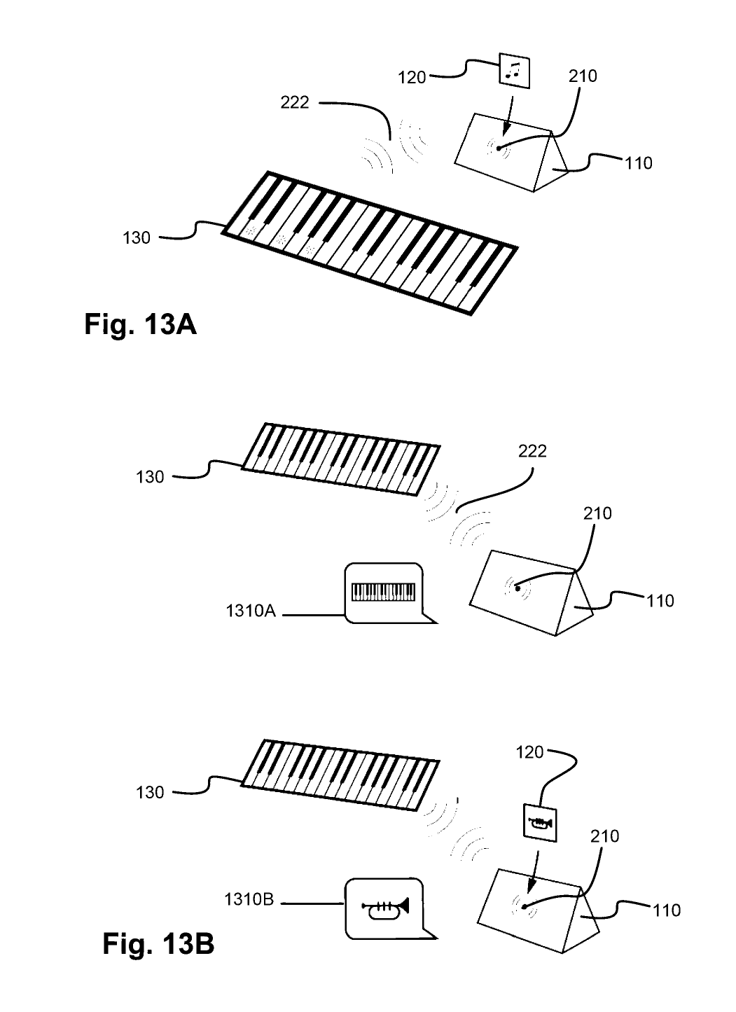

FIGS. 13A and 13B show arrangements for interacting with a peripheral device 130. In one arrangement, the peripheral device 130 is a keyboard. The device 110 detects, using the control interface module 210, the control object 120. Once detected, the device 110 executes one or more of the application programs 233 that are associated with the detected control object 120. The one or more application programs 233, in this arrangement, transmit instructions to the keyboard 130 to illuminate certain keys in order to guide a user to play in-time with a media being played over the speaker 215 of the device 110, as shown in FIG. 13A. Therefore, the key illumination of the keyboard 130 instructs the user how to play the keyboard 130 for the media being played. In other words, the processor of the peripheral device 130 communicates with the processor of the device 110 in order to perform an operation (e.g., lighting up keys of the keyboard) on the peripheral device 130.

In one alternative arrangement, the control object 120 is associated with instructions to change the sound emitted by the speaker 215 when receiving input from the keyboard 130. For example, as shown in FIG. 13B, the keyboard 130 is associated with the device 110, such that when a key of the keyboard 130 is pressed, then the speaker 215 of the device 110 plays the sound 1310A of a keyboard corresponding to the pressed key. The sound being emitted by the speaker 215 can then be changed by placing a control object 120 (associated with a sound to be emitted by the speaker 215) near the control interface module 210. The device 110 then changes the sound to be emitted by the speaker 215 to the sound associated with the detected control object 120, which in this case is the sound 1310B of a horn. Therefore, when a key of the keyboard 130 is pressed, the sound 1310E of a horn is played by the speaker 215.

In another arrangement, the control object 120 changes the sound emitted by the speaker 215. For example, if a microphone is being used as a peripheral device 130, the control object 120 changes the sound emitted by the speaker 215 to that of a robot or animal.

Interactivity with a Combined Device

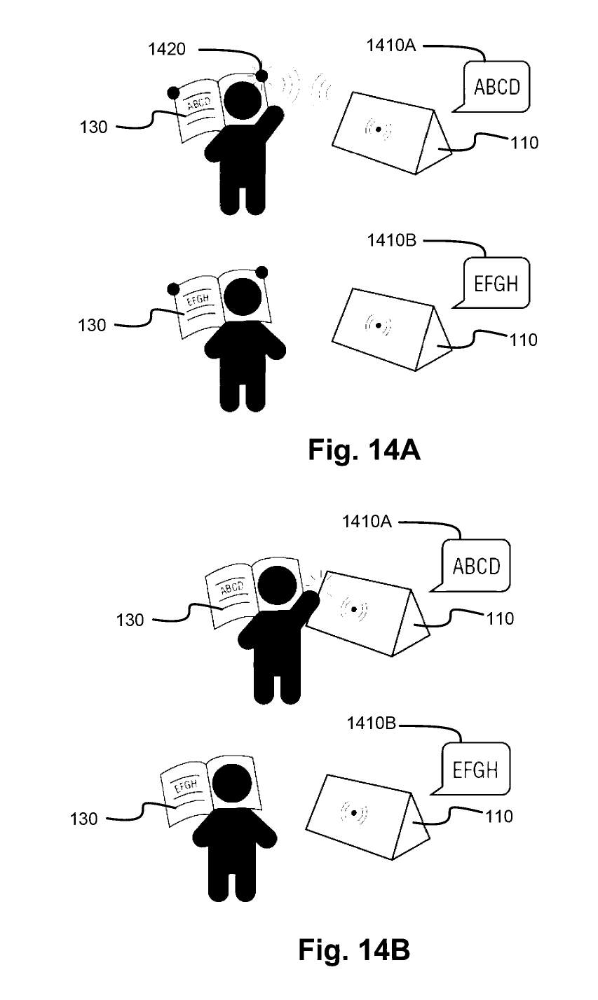

FIGS. 14A and 14B show arrangements for interacting with a combined device 130. In the example shown in FIGS. 14A and 14B, the combined device 130 is a book with an embedded control object 120 (not shown in FIGS. 14A and 14B). When the embedded control object 120 is detected by the control interface module 210, the device 110 executes one or more application programs 233 to: (1) playback audio associated with the embedded control object 120 through the speaker 215; and (2) activate the microphone 216 of the device 110 to enable a sound-recognition program to recognise a specific audible sound 1420 indicating turning of a page of the book 130 (i.e., a page turn mechanism). Such a sound 1420 may be a click or other low complexity sound, which may be integrated into the book 130. Another example is inaudible sound (e.g., high frequency sound that is inaudible to human ears) that is detectable by sensors (e.g., ultrasound sensitive microphone) of the device 110.

In an alternative arrangement, the book is not a combined device and the control object 120 is separate to the book. When the entertainment media device 110 detects a control object 120 associated with the book, then the device 110 plays audio of the associated book.

In an alternative arrangement, instead of the page turning mechanism using sound as described above, the device 110 executes a tap-recognition program to detect when the device 110 is tapped to indicate page turn. Audio playback relating to the book 130 continues when a tap on the device 110 is detected, as shown in FIG. 14B. Such a tap is detected by sensors (i.e. accelerometers) integrated into the device 110.

The audio playback of the book 130 commences on the first page of the book 130. The audio playback relating to the first page of the book 130 is shown in FIG. 14A as item 1410A. When the audio playback relating to the first page is completed, the audio playback is paused and the application programs 233 await for the turn page mechanism described above. Upon recognition, the device 110 plays the audio playback 141013 of the previous or next page dependant on the specific sound recognised.

Another example of the combined device 130 is a poster with numerous images which can be explained or taught to a child. Audio playback from the speaker 215 may be through pre-stored audio files, or via text to speech capabilities. The audio playback file may also be generated by scanning the text in the poster 130.

In another alternative arrangement, each page in the book 130) may be associated with a respective media file, which is accessible by placing the control object 120 near the device 110. For example, one page may have an image of a lion. Placing an associated control object 120 on the device 110 would play media associated with the lion. Another page may have an image of an elephant and a monkey. Placing an associated control object 120 on the device 110 may cycle between media associated with both the monkey and elephant.

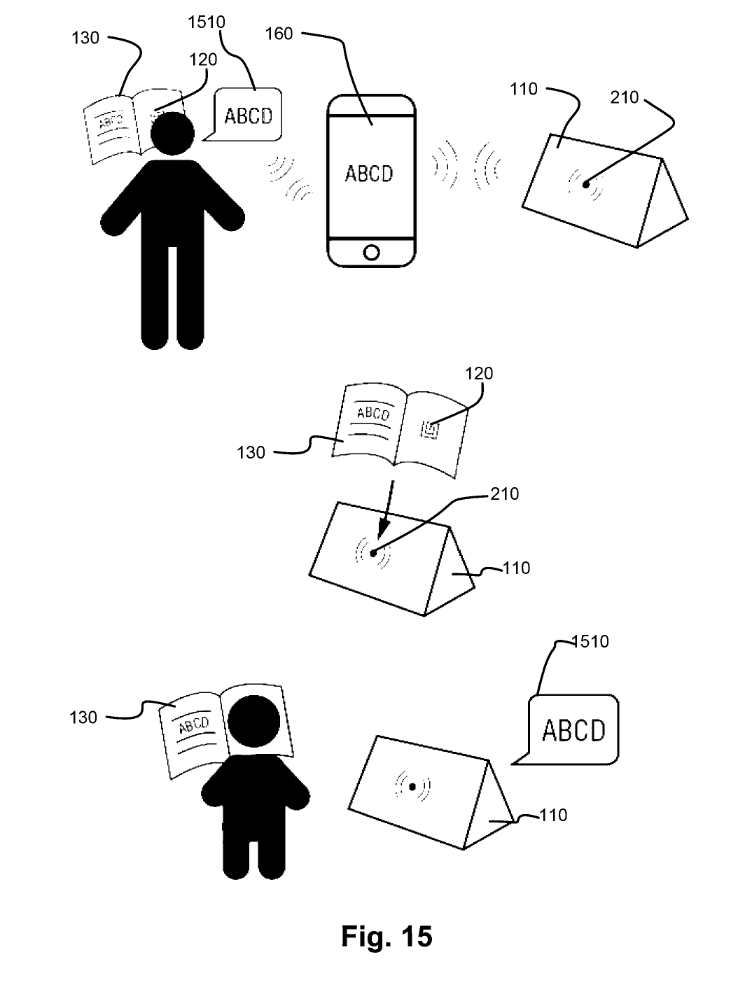

FIG. 15 shows a user recording the audio playback for the book 130. The user in this example uses the controller device 160 to record the audio playback and associate the recorded audio playback with the control object 120 embedded in the book 130. During recording, the user may also place markers associated with the audio playback file to indicate a page turn. Therefore, when the book 130 is scanned over the device 110 the recording is then played, allowing the child to read a book recited by his/her parent. The markers inserted into or alongside the audio recording are then able to be used to flow through the book as guided by a child. In an arrangement, the audio recording is played back based on the page turn mechanism described above,

The arrangement described above provides a more enriching experience for the child.

### Puzzle Play

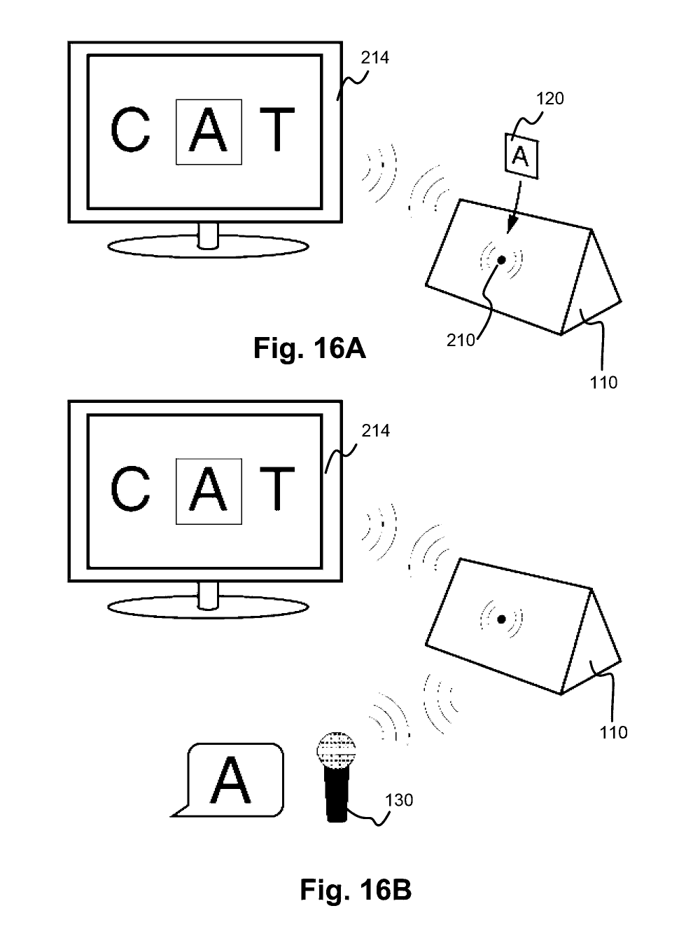

FIGS. 16A and 16B illustrate the entertainment media system 100 being used for puzzle play. FIG. 16 shows the device 110 instructing a screen 214 to display the words “C_T”. At the same time, the device 110 instructs a number of control objects 120 to display different letters, such as “A”, “X”, “C”, and the like (not shown). A user then selects and places a relevant control object 120 on the control interface module 210 to complete the word displayed on the screen 214. In this example, the correct control object 120 would be the control object 120 displaying the letter “A”.

Once the puzzle is completed, the application program 233 in the device 110 selects and displays a new word puzzle on the screen 214. At the same time, the program 233 changes the letters being displayed on the control objects 120. In an alternative arrangement, the program 233 guides the user to place the control objects 120 in the scan area 224 to enable the device 110 to change the letters on the control objects 120.

In an alternative arrangement, each of the control objects 120 is statically related to a letter. As described above, a user then selects and places a relevant control object 120 on the control interface module 210 to complete the word displayed on the screen 214. In the example above, the correct control object 120 would be the control object 120 statically displaying the letter “A”. In one alternative arrangement, a keyword associated with the control object 120 may be used to detect the correct response.

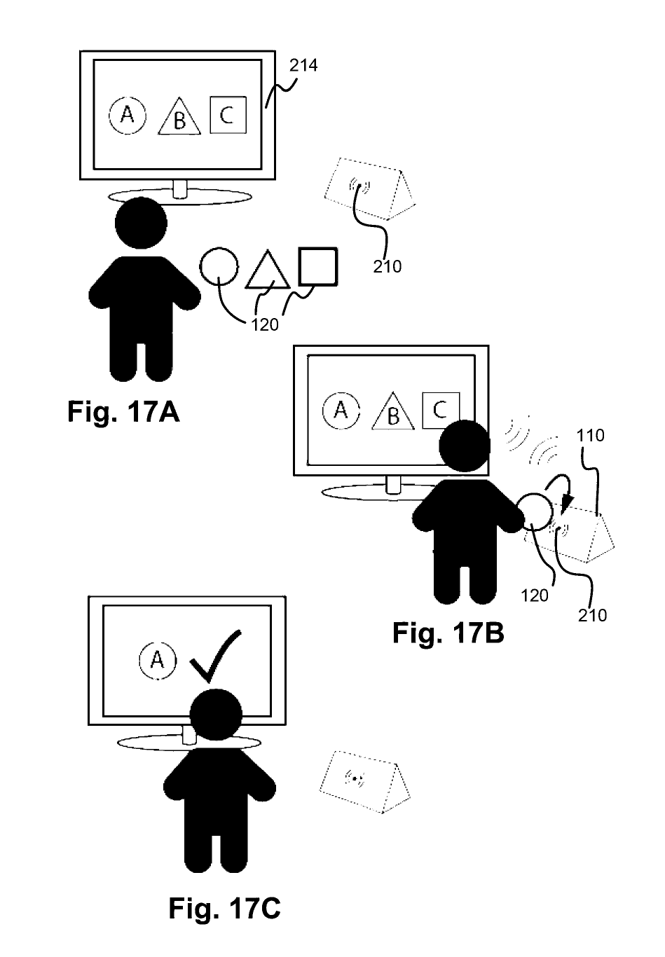

In one alternative arrangement shown in FIGS. 17A to 17C, the puzzle being displayed on the screen 214 relates to different shapes. In the example shown in FIG. 17A, the shapes are circle, triangle, and square. The control objects 120 shown are shaped accordingly. In another arrangement, the display of each of the control objects 120 is showing the shapes.

The screen 214 prompts a user to select from one of the shapes. In another arrangement, the program 233 asks the user a question and presents options for the answer on the screen 214 in the form of the shapes. The user can then select one of the control objects 120 to answer the question. When the correct control object 120 is placed on the control interface module 210 (as shown in FIG. 17B), the program 233 displays on the screen 214 that the answer is correct (as shown in FIG. 17C) and proceeds to the next puzzle. Otherwise, the program 233 asks the question again.

In this alternative arrangement, the letters are subtitled with a character or object (e.g., numbers, associated objects, rhyming objects, logical associations to a stated questions, etc.) to enable the puzzle play.

In an alternative arrangement shown in FIG. 16B, a peripheral device 130 such as a microphone, is used to capture the voice of the user. A voice-recognition software 233 on the device 110 receives the captured voice and determines the whether the answer is correct.

### Multi-Path Interactive Video

In one arrangement, the media entertainment system 100 implements a multi-path interactive video. For example, a video stream is shown on a screen 214 and, at different points of the video stream, the user is presented with choices (similar to the example shown in FIGS. 17A to 17C). The user then select one of the control objects 120 to select one of the choices. The choices enable many paths in progressing the story of the video stream, enabling the user to craft his/her own adventure when watching the video stream (i.e., an audio/video composition). This functionality may further be adapted to direct and teach the child user towards a correct answer being proposed/questioned by the interactive video.

### INDUSTRIAL APPLICABILITY

The arrangements described are applicable to the computer and data processing industries and particularly for the entertainment media devices.

The foregoing describes only some embodiments of the present invention, and modifications and/or changes can be made thereto without departing from the scope and spirit of the invention, the embodiments being illustrative and not restrictive.

In the context of this specification, the word “comprising” means “including principally but not necessarily solely” or “having” or “including”, and not “consisting only of”. Variations of the word “comprising”, such as “comprise” and “comprises” have correspondingly varied meanings.

1. A system comprising:
an entertainment media device comprising:
a first processor;
a first computer readable medium in communication with the first processor, the first computer readable medium comprising first computer program codes that are executable by the first processor to operate the entertainment media device;
and
a first control interface module in communication with the first processor, the first control interface module being configured for detecting the presence of a control object within a detection area of the first control interface module;
a control object comprising an identifier detectable by the first control interface module of the entertainment media device;
a storage device comprising a database storing associations between one or more identifiers with control information, the control information being control functions operable by the first processor of the entertainment media device;
wherein the first processor carries out the steps of:
determining, by the first control interface module, the identifier of the detected control object;
retrieving, from the database, control information of the entertainment media device associated with the determined identifier; and
executing the control information on the entertainment media device.

2. The system of claim 1, wherein the control object comprises:
a second processor;
a second computer readable medium in communication with the second processor, the second computer readable medium comprising the identifier of the control object and second computer program codes that are executable by the second processor to operate the control object;
a first communications interface in communication with the second processor, the first communications interface being configured for communicating with the first control interface module; and
a first power module configured for providing electrical power to the second processor, the second computer readable medium, and the first communications interface,
wherein the determining of the identifier of the detected control object by the first control interface module comprises:
transmitting a control signal requesting the identifier of the control object, wherein the transmission of the control signal is from the first processor, via the first control interface module, to the second processor, via the first communications interface; and
in response to receiving the control signal, the second processor retrieves the identifier from the second computer readable medium and transmits the retrieved identifier, via the first communications interface, to the first processor, via the first control interface module.

3. The system of claim 1 or 2,
the system further comprising:
a peripheral device comprising:
a third processor;
a third computer readable medium in communication with the third processor, the third computer readable medium comprising third computer program codes that are executable by the third processor to operate the peripheral device;
a third communications interface in communication with the third processor, the third communications interface being configured for communicating with the second communications interface; and
a second power module configured for providing electrical power to the third processor, the third computer readable medium, and the third communications interface,
wherein the third processor executing the third computer program codes communicates with the first processor executing the first computer program codes, via the second and third communication interface respectively, to pair the entertainment media device with the peripheral device.

4. The system of any one of claims 1 to 3,
wherein the entertainment media device further comprises a second communications interface configured to receive and transmit data;
the system further comprising:
a server configured for communicating with the entertainment media device via a computer network and the second communications interface, wherein the storage device is located at the server.

5. The system of claim 1, wherein the first computer readable medium stores media content for playback by the entertainment media device.

6. The system of claim 2, wherein the second computer readable medium stores media content for playback by the entertainment media device.

7. The system of claim 4, wherein the server stores media content for playback by the entertainment media device.

8. The system according to any one of the preceding claims, further comprising:
a controller device configured to communicate with the entertainment media device to send and receive data from the entertainment media device.

9. The system according to claim 8, wherein the data comprises:
control data for controlling the operation of the entertainment media device;
audio data;
video data;
and any combinations of the above.

10. The system of any one of the preceding claims, wherein the control information includes function controls of the entertainment media device.

11. The system of any one of claims 3, and 4, 7 to 10, when the claims 4, 7 to 10 are dependent on claim 3, wherein the control information further includes function controls of the peripheral device.

12. The system of any one of claims 2 to 11, wherein the first processor sends control signal to the second processor, via the control interface module, to modify the data stored in the second computer readable medium.

13. The system of claim 12, when dependent on claim 6, wherein the controller device controls the operation of the entertainment media device to modify the data stored in the second computer readable medium.

14. The system of any one of the preceding claims, wherein the first control interface module is configured for detecting movement of the control object within the detection area such that the movement of the control object is associated with second control information for controlling the entertainment media device.

15. The system of any one of claims 3 and 4 to 14, when dependent on claim 3, wherein the peripheral device further comprises:
a second control interface module configured for detecting the presence of the control object within a detection area of the second control interface module and determining the identifier of the detected control object, the second control interface module being in communication with the third processor, wherein the third processor sends the determined identifier of the detected control object to the first processor for the first processor to:
retrieve, from the database, control information of the entertainment media device associated with the identifier received from the third processor; and
executing the control information on the entertainment media device.

16. The system of any one of the preceding claims, wherein the first control interface modules comprises a plurality of control interface modules, each of the plurality of control interface modules configured to interact with the control object to retrieve different control information.

17. The system of any one of claims 2 to 16, wherein the data transmitted and received by the first and second control interface modules, the first communications interface, the second communications interface, and the third communications interface is encrypted.

18. The system of any one of the preceding claims, wherein the entertainment media device further comprises a path, wherein the detection area of the first control interface module is configured to detect the control object on the path.

19. The system of any one of the preceding claims, wherein the entertainment media device comprises a sensor, wherein the sensor is an accelerometer configured to enable the first processor to determine the orientation of the entertainment media device.

20. The system of claim 19, wherein the control information retrieved by the first control interface module is dependent on the determined orientation.

21. The system of any one of the preceding claims, wherein the control object further comprises a display for displaying information.

22. The system of claim 21, wherein the display is updateable.

23. The system of any one of the preceding claims, wherein the identifier comprises identifiable features, and wherein the first processor or the server is configured to characterise the identifiable features and to select the control information from the characterised identifiable features using a probability based algorithm.

24. A method of operating a system comprising: an entertainment media device comprising a first processor; a first computer readable medium in communication with the first processor, the first computer readable medium comprising first computer program codes that are executable by the first processor to operate the entertainment media device; and a first control interface module in communication with the first processor, the first control interface module being configured for detecting the presence of a control object within a detection area of the first control interface module; a storage device comprising a database storing associations between one or more identifiers with control information, the control information being control functions operable by the processor of the entertainment media device; a control object comprising an identifier detectable by the first control interface module of the entertainment media device; the method comprising:
determining, by the first control interface module, the identifier of the detected control object;
retrieving, from the database, control information of the entertainment media device associated with the determined identifier; and
executing the control information on the entertainment media device.

25. The method of claim 24, wherein the control object comprises: a second processor; a second computer readable medium in communication with the second processor, the second computer readable medium comprising the identifier of the control object and second computer program codes that are executable by the second processor to operate the control object; a first communications interface in communication with the second processor, the first communications interface being configured for communicating with the first control interface module; and a first power module configured for providing electrical power to the second processor, the second computer readable medium, and the first communications interface, wherein the determining of the identifier of the detected control object by the first control interface module comprises:
transmitting a control signal requesting the identifier of the control object, wherein the transmission of the control signal is from the first processor, via the first control interface module, to the second processor, via the first communications interface; and
in response to receiving the control signal, the second processor retrieves the identifier from the second computer readable medium and transmits the retrieved identifier, via the first communications interface, to the first processor, via the first control interface module.

26. The method of claim 24 or 25, wherein the system further comprises a peripheral device comprising: a third processor; a third computer readable medium in communication with the third processor, the third computer readable medium comprising third computer program codes that are executable by the third processor to operate the peripheral device; a third communications interface in communication with the third processor, the third communications interface being configured for communicating with the second communications interface; and a second power module configured for providing electrical power to the third processor, the third computer readable medium, and the third communications interface, the method further comprising:
executing, by the third processor, the third computer program codes for communicating with the first processor executing the first computer program codes, via the second and third communication interface respectively, to pair the entertainment media device with the peripheral device.

27. The method of any one of claims 24 to 26, wherein the entertainment media device further comprises a second communications interface configured to receive and transmit data, the method further comprising:
communicating, by a server, with the entertainment media device via a computer network and the second communications interface, wherein the storage device is located at the server.

28. The method of claim 24, wherein the first computer readable medium stores media content for playback by the entertainment media device.

29. The method of claim 25, wherein the second computer readable medium stores media content for playback by the entertainment media device.

30. The method of claim 27, wherein the server stores media content for playback by the entertainment media device.

31. The method according to any one of claims 24 to 30, wherein the system further comprises a controller device, the method further comprising:
communicating, by the controller device, with the entertainment media device to send and receive data from the entertainment media device.

32. The method according to claim 31, wherein the data comprises:
control data for controlling the operation of the entertainment media device;
audio data;
video data;
and any combinations of the above.

33. The method of any one of claims 24 to 32, wherein the control information includes function controls of the entertainment media device.

34. The method of any one of claims 26, and 27, 30 to 33, when the claims 27, 30 to 33 are dependent on claim 26, wherein the control information further includes function controls of the peripheral device.

35. The method of any one of claims 25 to 34, wherein the control signal is being sent by the first processor to the second processor, via the control interface module, to modify the data stored in the second computer readable medium.

36. The method of claim 35, when dependent on claim 31, the method further comprising:
controlling, by the controller device, the operation of the entertainment media device to modify the data stored in the second computer readable medium.

37. The method of any one of claims 26 to 36, the method further comprising:
detecting, by the first control interface module, movement of the control object within the detection area such that the movement of the control object is associated with second control information for controlling the entertainment media device.

38. The method of any one of claims 26 and 27 to 37, when dependent on claim 26, wherein the peripheral device further comprises: a second control interface module configured for detecting the presence of the control object within a detection area of the second control interface module and determining the identifier of the detected control object, the second control interface module being in communication with the third processor, wherein the third processor sends the determined identifier of the detected control object to the first processor, the method further comprising:
retrieving, from the database, control information of the entertainment media device associated with the identifier received from the third processor; and
executing the control information on the entertainment media device.

39. The method of any one of claims 24 to 38, wherein the first control interface modules comprises a plurality of control interface modules, the method further comprising:
interacting, by each of the plurality of control interface modules, with the control object to retrieve different control information.

40. The method of any one of claims 25 to 39, wherein the data transmitted and received by the first and second control interface modules, the first communications interface, the second communications interface, and the third communications interface is encrypted.

41. The method of any one of claims 24 to 40, wherein the entertainment media device comprises a sensor, wherein the sensor is an accelerometer, the method further comprising:
enabling the first processor to determine the orientation of the entertainment media device using the accelerometer.

42. The method of claim 41, wherein the control information retrieved by the first control interface module is dependent on the determined orientation.

43. The method of any one of claims 26 to 43, wherein the control object further comprises a display, the method further comprising: displaying, by the display, information.

44. The method of claim 43, the method further comprising:
updating the display.

45. The method of any one of claims 24 to 44, wherein the identifier comprises identifiable features, the method further comprising:
characterising, by the first processor or the server, the identifiable features; and
selecting, by the first processor or the server, the control information from the characterised identifiable features using a probability based algorithm.

46. A computer program product comprising software instructions, the software instructions executable by a system to cause the system to perform the method of any one of claims 24 to 45.
